(19) United States
(12) Patent Application Publication
(10) Pub. No.: US 2025/0078184 A1
(43) Pub. Date: Mar. 6, 2025

(54) DECENTRALIZED PROTOCOL FOR TOKEN-BASED RESOURCE ALLOCATION

(71) Applicant: EL-DAR AL-KHASSEH LTITWER AL-OMRANI Ltd., Jeddah (SA)

(72) Inventors: Essam Fakieh, Jeddah (SA); Ahmed A. Fadol, Washington, DC (US)

(21) Appl. No.: 18/809,216

(22) Filed: Aug. 19, 2024

Related U.S. Application Data
(60) Provisional application No. 63/535,871, filed on Aug. 31, 2023.

(51) Int. Cl. G06Q 50/16; G06Q 20/38; G06Q 40/03

(52) U.S. Cl. CPC G06Q 50/16; G06Q 20/389; G06Q 40/03

(57) ABSTRACT

Described is a system for a decentralized protocol for token-based resource allocation by receiving a real estate possession record for a real estate from a real estate possessor, identifying a value of the real estate, transmitting generated digital tokens to a digital token storage associated with the real estate possessor, and recording a lien on the real estate possession record. The system initiates a first digital token relocation for a real estate recipient, and periodically, during a real estate utilization period for a real estate user: receives an indication of a second digital token relocation from the real estate user, transmits the first portion of the second digital token relocation to the possessor, transmits a second portion to the real estate recipient, and records a record of the first and second portions being transmitted onto the distributed ledger of the blockchain.

### CLAIM OF PRIORITY

This patent application claims the benefit of U.S. Provisional Patent Application No. 63/535,871, filed Aug. 31, 2023, entitled “Decentralized Protocol for Token-Based Resource Allocation”, which is incorporated by reference herein in its entirety.

### TECHNICAL FIELD

The present disclosure relates generally to a tokenization system, and more specifically to decentralized protocol for token-based resource allocation.

### BACKGROUND

Traditional home ownership often involves acquiring a mortgage from a financial institution like a bank or a mortgage lender. In this setup, an aspiring homeowner, upon finding a suitable property, applies for a mortgage loan. The lender evaluates the applicant's creditworthiness based on their financial history, current income, and debt levels, among other factors. If the application is approved, the lender provides the funds necessary to purchase the home, and the homebuyer agrees to repay the loan over a predefined period, typically in monthly installments over 15 to 30 years. The property serves as collateral, which means that if the borrower fails to make the required payments, the lender has the right to take possession of the home (foreclosure) and sell it to recover their funds. Over time, as the homebuyer makes their mortgage payments, they gradually build equity in the home, which represents their financial stake or ownership interest in the property. When the loan is fully repaid, the lender releases the lien to the deed, indicating full ownership to the home buyer.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 illustrates an architecture for tokenizing of a real estate asset, according to some examples.

FIG. 2 illustrates an architecture comparing conventional mortgage and rental systems with the tokenization system regarding ownership of the property over time, according to some examples.

FIG. 3 illustrates an architectural diagram between the tokenization system, asset owners, and individuals, according to some examples.

FIG. 4 illustrates an example method for decentralized protocol for token-based resource allocation, according to some examples.

FIG. 5 illustrates an architectural diagram of tokenized returns, according to some examples.

FIG. 6 illustrates an example architecture for the right of use, fractional ownership, and ownership of an asset, according to some examples.

FIG. 7 illustrates a first mode for a conventional loan, according to some examples.

FIG. 8 illustrates a second mode for another loan without collateral, according to some examples.

FIG. 9 illustrates a third mode regarding collateral for a loan, according to some examples.

FIG. 10 illustrates a third mode illustrating token relocation based on appreciation in value of the property, according to some examples.

FIG. 11 illustrates a fourth mode illustrating token relocation based on a sudden change in value of the property, according to some examples.

FIG. 12 illustrates fungible usage rights, according to some examples.

FIG. 13 illustrates an example of a multi-user multi-asset-slot scenario with tokenized real world assets, according to some examples.

FIG. 14 is a diagrammatic representation of a machine in the form of a computer system within which a set of instructions may be executed to cause the machine to perform any one or more of the methodologies discussed herein, according to some examples.

FIG. 15 is a block diagram showing a software architecture within which examples may be implemented.

FIG. 16 illustrates a machine-learning pipeline, according to some examples.

FIG. 17 illustrates training and use of a machine-learning program, according to some examples.

FIG. 18 illustrates tokenization of an asset as a whole, according to some examples.

FIG. 19 illustrates tokenization of an asset that is divisible into parts, according to some examples.

FIG. 20 illustrates tokenizing ownership and/or usage across time, according to some examples.

FIG. 21 illustrate tokenizing ownership and/or usage across time and parts, according to some examples.

FIG. 22 illustrates tokenization for use allocations, according to some examples.

FIG. 23 illustrates token generation based on location, according to some examples.

FIG. 24 illustrates token generation for copies of goods, according to some examples.

### DETAILED DESCRIPTION

Traditional real estate and mortgage systems have several significant drawbacks that make them less effective for today's dynamic environment. Traditional mortgage systems are generally rigid and inflexible. They do not easily adjust to changing circumstances of homeowners, making them prone to risk. If homeowners encounter financial difficulties, the homeowners may default on their mortgage payments, leading to foreclosure and loss of their investment.

Traditional systems also require a large down payment (usually around 20% of the property's value) and the homeowner takes a loan for the remainder, creating significant upfront costs and ongoing financial risk. This creates a high barrier to entry, preventing many from becoming homeowners.

Real estate is also known as an illiquid asset. Buying and selling properties can be a time-consuming processes, which could be a significant issue for individuals who need quick access to cash.

Traditional transactions involve many intermediary systems and require significant paperwork. This can lead to delays, inefficiencies, and high transaction costs including realtor fees, closing costs, notary fees, and other administrative charges.

Real estate transactions can be complex and lack transparency. This complexity can lead to fraudulent activities such as double spending, selling disputed properties, or fraudulent alterations to property deeds, creating mistrust and uncertainty in the market.

After the mortgage is approved and all terms are agreed upon, the process of transferring funds, paying all related fees, and finalizing the transaction can be complex and time-consuming, requiring a high level of coordination among multiple parties, and any missteps can result in significant delays.

In traditional systems, renters essentially pay for the privilege of living in a property without accruing any long-term equity, leaving them at a significant disadvantage compared to homeowners. Traditional systems do not offer a mechanism for renters to transition to ownership. A renter may have paid significant amounts to rent over several years but still lack the funds for a down payment on a house.

Traditional mortgages place the risk predominantly on the borrower. If the value of the property falls or the borrower's financial situation changes, the borrower bears the brunt of the financial impact. Moreover, the lender takes a very large risk of default by underwriting a mortgage for a substantial portion of the property's value to the purchaser.

Traditional systems do not provide a way for homeownership to be achieved incrementally. This is especially disadvantageous for younger people or those in lower income brackets who might not be able to afford the high initial cost of buying a home outright.

Examples of the example tokenization system as described herein mitigate and/or eliminate the pitfalls of traditional systems as described above. The tokenization system described herein overcomes these challenges by offering a flexible, transparent, efficient, and cost-effective alternative to traditional real estate transactions and mortgage systems.

The tokenization system allows homeowners to gradually purchase tokens representing fractional ownership in a property over time. This provides more flexibility compared to rigid traditional mortgages with fixed payment schedules. Homeowners can purchase additional tokens or sell owned tokens based on changing financial circumstances.

Since homeowners only need to purchase a portion of tokens initially, the barrier to entry is lower. Large down payments are no longer required. Homeowners can start with a smaller upfront investment and gradually work towards full ownership. This makes homeownership more accessible. Real estate tokens minted by the tokenization system also provide liquidity compared to illiquid traditional properties. Homeowners can quickly sell owned tokens on the open market if they need to access funds.

The tokenization system utilizes blockchain and smart contracts to streamline transactions. This eliminates paperwork, intermediaries, and administrative fees associated with traditional systems. Transactions can be executed faster, more efficiently, and at lower cost. Moreover, token transactions leverage blockchain's transparency and immutability. All transactions are visible on the public ledger, reducing potential for fraud or disputes over property ownership.

After terms are agreed upon, transactions can be executed immediately upon payment unlike traditional closings which require extensive coordination. This provides faster access to funds and property.

Renters can purchase tokens over time during their lease, gradually earning equity that can be applied to ownership of the rental property or a future property. This provides a path to ownership for renters lacking funds for a traditional down payment.

Furthermore, features of the tokenization system distribute risk across many token holders rather than a single entity. If property value declines, no single party bears the full brunt. If a homeowner sells their tokens, risk is transferred to the buyer. Also, incremental purchases of tokens allow for gradual steps towards full ownership. This makes owning a home affordable even for those with limited current funds.

When the effects in this disclosure are considered in aggregate, one or more of the methodologies described herein may improve known systems, providing additional functionality (such as, but not limited to, the functionality mentioned above), making such systems easier, faster, or more intuitive to operate, and/or obviating a need for certain efforts or resources that otherwise would be involved in the tokenization process. Computing resources used by one or more machines, databases, or networks may thus be more efficiently utilized or even reduced.

### Tokenization of Asset

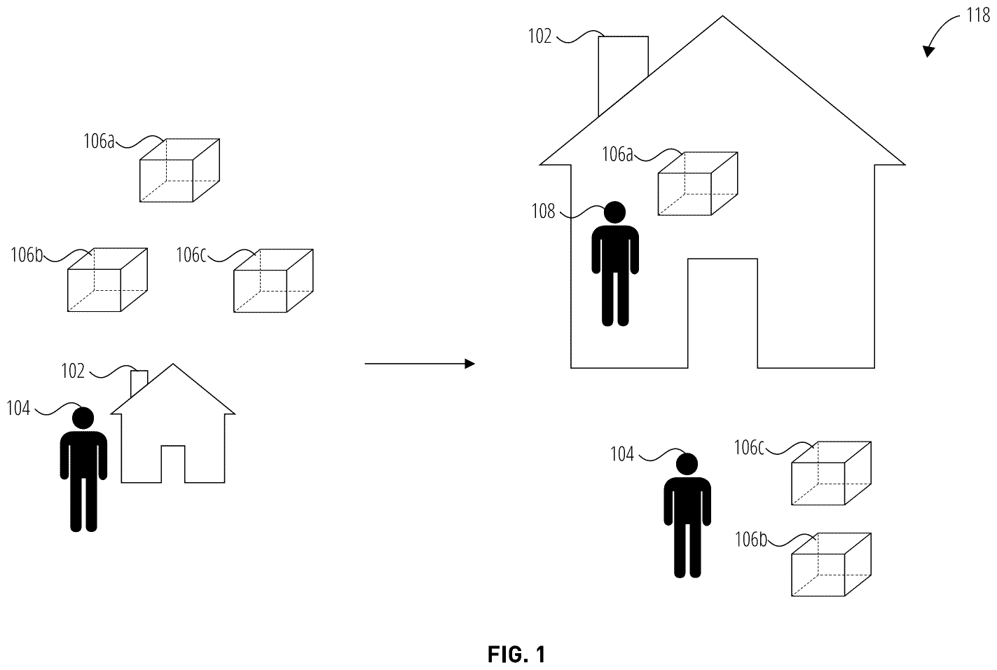

FIG. 1 illustrates an architecture 118 for tokenizing of a real estate asset, according to some examples. The process of tokenizing a home or an asset by the tokenization system can be described into several steps.

One step is for the tokenization system to evaluate the property to determine its current market value. In some cases, the tokenization system employs technological methods for estimating the value of a property. In some cases, the tokenization system compares the property to similar properties in the same area that have been sold recently by retrieving data from third party real estate databases.

In some cases, the tokenization system applies a regression analysis that can determine how different variables (like location, size, age, number of rooms, and nearby amenities) impact the property's value. The algorithm is trained on a vast dataset of property sales to learn the weight of each variable.

In some cases, the tokenization system applies Geographic Information System (GIS) data, which includes geographical and topological data about a property and its surroundings. The tokenization system applies this data to assess the value based on physical features like proximity to water bodies, hills, parks, and more.

In some cases, the tokenization system applies one or more artificial neural networks to predict property values. The neural network is trained on a large dataset and can handle complex, non-linear relationships between variables (such as data related to the property and other similar assets), making the estimate more accurate.

Although artificial intelligence, neural networks, and machine learning models are disclosed as performing certain features, it is appreciated that a machine learning model can be trained and applied by the tokenization system to perform any or all of the features of the tokenization system as described herein. For example, a first machine learning model facilitates decisioning by the tokenization system between modules and other machine learning models, whereas a second machine learning model generates a prediction of property values.

Systems and methods described herein include training a machine learning network, such as training to generate smart contracts, predict property values, mint tokens, facilitate transactions to various individuals and wallets, perform features on deeds and ownership, and/or the like. The machine learning network can be trained to perform one or more of the features for the tokenization system as described herein.

The machine learning algorithm can be trained using historical information. For example, the machine learning model is trained to generate smart contracts by applying historical real estate transactions for use cases on the tokenization system, resulting in self-executing smart contracts which are deployed on the blockchain (e.g., sent to the blockchain network and stored on the distributed ledger).

Training of models, such as artificial intelligence models, is necessarily rooted in computer technology, and improves modeling technology by using training data to train such models and thereafter applying the models to new inputs to make inferences on the new inputs. Here, the new inputs can be information relating to a new homeowner requesting tokenization of the home to rent and slowly sell the home to a new tenant. The trained machine learning model performs the various features of enabling the homeowner to tokenize the home and enable the new tenant to progressively own the home.

Such training involves complex processing that typically requires a lot of processor computing and extended periods of time with large training data sets, which are typically performed by massive server systems. Training of models can require logistic regression and/or forward/backward propagating of training data that can include input data and expected output values that are used to adjust parameters of the models.

Such training is the framework of machine learning algorithms that enable the models to be applied to new and unseen data (such as new tenant or asset owner data) and make predictions that the model was trained for based on the weights or scores that were adjusted during training. Such training of the machine learning models described herein reduces false positives and increases the performance.

Once the property value is established, the homeowner submits a digital version of the deed to the tokenization system. This deed serves as a legal proof of ownership and will be held by the tokenization system for the duration of the rental agreement.

Using the property's evaluated value and a particular value for each token (whether a predefined value or current market value), the tokenization system determines a number of tokens to be minted. For example, if a home 102 of FIG. 1 is valued at $300,000 and each token is worth $100,000, the system mints 3 digital tokens 106a, 106b, 106c (collectively referred to herein as digital tokens 106). These tokens are digital representations of ownership in the property.

The tokenization system mints new tokens on the blockchain or distributed ledger by creating new digital tokens or coins. First, the tokenization system generates a smart contract and is deployed to the blockchain. This contract serves as the blueprint for the new tokens and contains rules about how the tokens can be transferred, how many will exist, and other necessary specifications.

Once the smart contract is live, the blockchain invokes the smart contract to mint new tokens. When the mint function is called, a specified number of tokens are created and assigned to the specified owner's address. In this case, an asset owner 104 is assigned as the owner of the digital tokens 106 representing full ownership of the home 102. As the minted tokens are then awarded to the homeowner, the tokenization system effectively converts the real estate into a digital form of ownership that can be divided, sold, or traded.

Although the examples described herein explain blockchain technology, digital ledger technology, tokens, and/or smart contracts to apply to particular examples, it is appreciated that the features of the tokenization system can be applied to other blockchains, tokens, and/or smart contracts. For example, blockchain technology can be applied to predict property values, and mint tokens, whereas smart contracts can be applied to facilitate a transaction (such as a payment) to various individuals and wallets, perform features on deeds and ownership, and/or the like.

The advent of blockchain technology, tokenization, and/or smart contracts improve trusts in the tokenization system using various features rooted in technology. Blockchain technology ensures that once a transaction is recorded on the blockchain, it can't be changed. In the context of the tokenization system, once the owner receives tokens corresponding to their property's value, that transaction is recorded permanently. The same goes for each token that a tenant purchases. This creates a clear, immutable record of who owns the asset, making the system much more trustworthy.

Moreover, every transaction on the blockchain is visible to all network participants. This means that the process of tokenization, as well as each subsequent token purchase, is completely transparent. No one can secretly change the number of tokens or alter the value of the asset, because such a change would be visible to everyone on the network.

The decentralized nature of blockchain also contributes to its trustworthiness. Rather than relying on a single entity (like a bank or government) to verify transactions, blockchain uses a network of nodes (computers). Each node has a copy of the blockchain, and transactions are verified through a consensus process. In essence, multiple parties agree on the validity of transactions, making it virtually impossible for fraudulent activity to occur.

The tokenization system can use smart contracts to facilitate one or more processes of the tokenization system. The tokenization system writes (or a machine learning model automatically generates) smart contracts to automatically perform features of the tokenization system as described herein, such as transferring tokens from the tenant to the owner upon receipt of a transaction (such as a payment), and transferring ownership of the asset once all tokens have been purchased. Smart contracts execute automatically when certain conditions are met, and because they're also stored on the blockchain, they're transparent, immutable, and verifiable.

Tokenization of asset ownership, such as in the case of real estate, provides enhanced security and privacy in several ways. With the blockchain or similar decentralized technology that underlies tokenization, there's no central authority holding all the data. This makes it harder for cybercriminals to exploit a single point of failure.

Moreover, once a transaction is recorded and confirmed on the blockchain, it can't be altered or tampered with. This prevents any fraudulent changes to the ownership records. Every token can be tracked from its inception, offering a clear and indisputable lineage of ownership.

Blockchain uses strong cryptographic algorithms to ensure the data in the blockchain can only be read by those involved in the transaction. This means personal and financial data can be securely stored and transferred. The tokenization system applies cryptography to tokenize real estate or any asset on a blockchain. In some cases, the tokenization system applies a public-key (asymmetric) cryptography using pairs of keys: public keys (which may be known to others), and private keys (which are known only to the owner).

The generation of such keys depends on cryptographic algorithms based on mathematical problems to produce one-way functions. The owner of the private key can use the key to sign transactions or data, and anyone with the public key can verify the signature. In the context of blockchain tokenization, the ownership of tokens (and therefore the real estate) can be proven by the possession of the private key.

The tokenization system includes a hash function, which given an input, produces a fixed size string of bytes. Every transaction in a blockchain can be hashed and the hash value is stored in the block. Any change in the transaction data would change the hash, which can easily be checked. These hash functions ensure data integrity.

When a token owner wants to transfer their tokens (representing ownership or equity in a real estate property), the token owner can create a transaction and sign it with their private key. This digital signature proves that the transaction was created by the actual owner and was not tampered with. Anyone can verify the signature with the corresponding public key, but they cannot forge the signature without the private key.

In some cases, the tokenization system encrypts sensitive data using the public key which can only be decrypted using the corresponding private key. This means even if someone else gets hold of this encrypted data, they can't read or understand it without the private key.

These cryptographic features and algorithms of the tokenizing system underpin the security, trust, and immutability aspects of the asset-backed tokens that represent equity in the asset. Such use of keys improves data security by restricting unauthorized use, view, and/or recordation of data onto the tokenization system.

These keys are used to authenticate users to data (such as ownership) or transactions (such as a request to tokenize a real estate) which increases security, prevents unauthorized access by third parties, and enables users of the tokenization system to apply features in an easily implemented way. Moreover, such encryption features are necessarily rooted in computer technology.

With tokenization, personal details can be kept private while still proving ownership. Rather than sharing all of your personal information, a token representing ownership can be transferred while your personal data stays secured.

The tokenization system applies smart contracts which are self-executing contracts embedded with the terms of the agreement directly written into code and/or onto the distributed ledger. The smart contracts permit trusted transactions and agreements to be carried out among disparate parties without the need for a central authority, legal system, or external enforcement mechanism.

Traditional transactions typically involve intermediaries, such as banks or transaction processors, that have access to all transaction data. With blockchain technology, transactions are made directly between parties, which means that sensitive data, such as transaction information, isn't exposed to third-party companies. This reduces the risk of sensitive data being intercepted or misused.

In summary, through the use of blockchain and tokenization, you can create a secure, transparent system for real estate ownership and transactions that minimizes the risk of fraud, protects privacy, and enhances the security of sensitive data.

A tenant 108 rents the property and, in addition to paying rent, begins to purchase tokens from the homeowner. These transactions can be made separately or as part of the rent payment. Over the duration of the lease, the tenant can acquire one or more tokens, such as digital token 106a, thereby gaining a portion of ownership in the property.

As the tenant begins to acquire tokens, the proceeds or dividends from the property are divided among the token holders based on their percentage of ownership. In the given example, if the tenant 108 has acquired one digital token 106a, the tenant would receive ⅓ of the proceeds, while the homeowner would receive ⅔. The proceeds to the tenant can be less than ⅓ of the rent as the proceeds can be determined by subtracting expenses from the rent (such as insurance, property tax, property management). The homeowner could get more than ⅔ if the homeowner is the one performing property management.

This technical method of tokenization enables gradual transfer of ownership from the homeowner to the tenant and provides both parties with more flexibility and liquidity than traditional systems. It also allows for a more seamless and efficient real estate transaction process, reducing the need for intermediaries and reducing costs.

The tokenization system uses a combined order of specific procedures that tokenizes real world properties that represent ownership, and these tokens are used in a variety of different and novel ways as described herein. Not only do some examples and features of the tokenization system eliminate the need for intermediaries that are typical in the home purchasing process, the process of the tokenization system is also different than the process for traditional systems.

The tokenization does not simply automate traditional systems and concepts. By leveraging tokenization technology, the tokenization system enables efficiencies and improvements to the real estate world, such as by leasing of ownership and partial ownership, progressive ownership as a tenant using the property, deed recordation and ownership facilitation, other features of the ownership tokens, and/or the like.

Conventional Mortgage and Rental Compared with Tokenization System Regarding Ownership Over Time

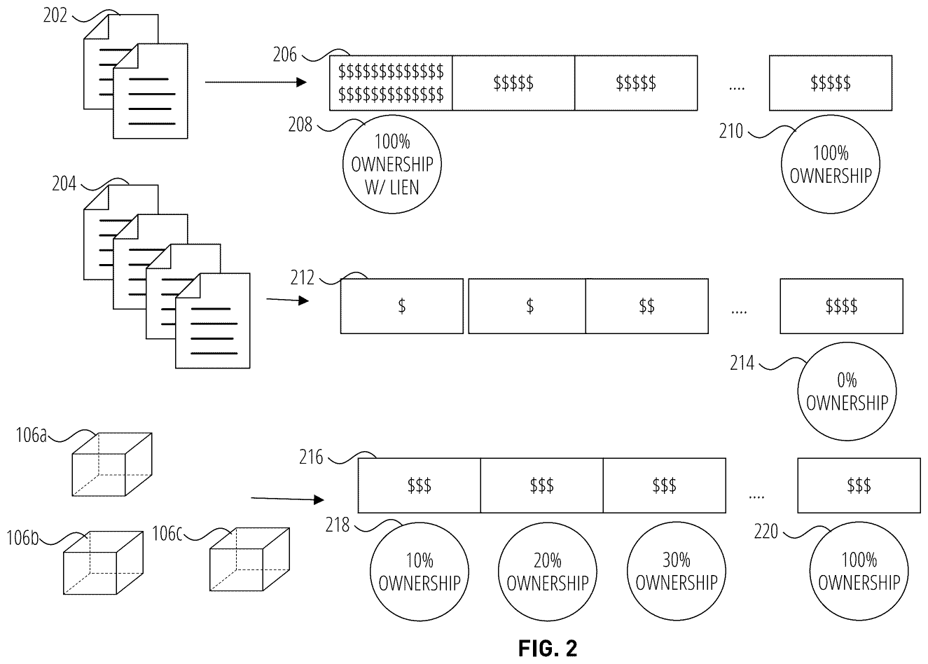

FIG. 2 illustrates an architecture comparing conventional mortgage and rental systems with the tokenization system regarding ownership of the property over time, according to some examples.

In a conventional mortgage system, the homebuyer typically pays a large down payment 206, often 20% of the home's value, and borrows the remaining 80% from a bank or other lending institution. The homebuyer gets legal 100% ownership of the property through a deed, but the lender also has a lien on the property (100% ownership with a lien 208), meaning they can foreclose and take possession if the homebuyer fails to make mortgage payments. The deed 202 is provided to the new buyer.

Integration with land record databases—The system could interface directly with public land records to submit lien documents for recording and retrieve confirmation. In some cases, the tokenization system implements self-executing smart contracts that automatically notifies relevant third party databases that have their own record (such as records of liens and ownerships), transfer lien-related assets, and/or record the lien on the blockchain upon meeting coded conditions.

In some cases, the tokenization system applies IoT sensors, such as sensors on deed documents could track their physical location and confirm when they are processed by the registrar's office. In some cases, the tokenization system applies computer vision algorithms, such as scanning deed documents and verifying registrar stamps and signatures using OCR and image analysis to validate recording (such as lien recording). In some cases, the tokenization system applies web scrapers to scrap public land record sites to check for lien recording and confirm registration details.

In some cases, the tokenization system applies Application Programming Interfaces (API) that interface with registrar's office databases, and submit via API lien data and retrieve recording confirmation of lien recordation programmatically. In some cases, the tokenization records the lien on a distributed ledger, such as recording the lien cryptographically on a blockchain to decentralized ledger.

Over the term of the loan, which could be 15 to 30 years, the homebuyer pays off the borrowed amount along with interest. The interest payments can significantly increase the total amount the homebuyer pays for the home. However, throughout this period, the homebuyer gradually gains equity in the home with each mortgage payment the homebuyer makes, and once the mortgage is fully paid, the homebuyer owns the home outright with 100% ownership 210 without a lien.

When a tenant rents a property, a contract 204 is signed between the tenant and the property owner that includes rental terms. The tenant pays a set amount 212 each month for the use of the property but gains no ownership or equity. Moreover, the rent could increase as time passes. This is typically the least costly option in the short term, as the tenant only pays for the use of the property and don't have to provide a large upfront down payment or pay interest. However, at the end of the lease, the tenant has 0% ownership 214 in the property, and all the money the tenant paid in rent does not contribute to any form of property ownership.

In contrast, the tokenization system combines elements of both mortgages and rentals while leveraging the advantages of tokenization technology. When the tenant uses this tokenization system, the tenant starts renting the property and also purchases digital tokens 106 over time. Each token represents a fraction of ownership in the property. Each month, the tenant makes payments 216 for the rental of the property and also for the tokens. The tenant gradually builds equity in the property (such as 10% ownership 218 initially) without needing to provide a large down payment upfront or pay high amounts of interest to a lender. Over time, and as leases renew, the tenant accumulates enough tokens to own the property outright at 100% ownership 220 without any liens and risks of default. The tokenization system provides the flexibility to move without the need to sell property, given that the tokens can be sold, transferred, and/or held. The tenant also has the ability to acquire ownership over time, thereby making homeownership more accessible for more people.

### Architectural Diagram Between the Tokenization System, Asset Owners, and Individuals

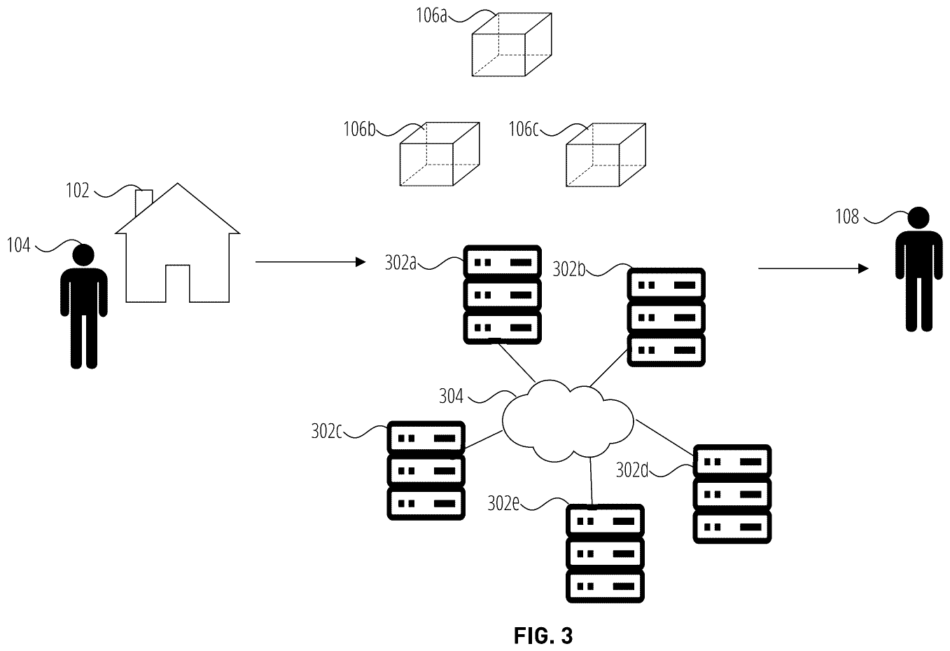

FIG. 3 illustrates an architectural diagram between the tokenization system, asset owners, and individuals, according to some examples. A group of computers 302a, 302b, 302c, 302d, and 302c (collectively referred to as the group of computers 302) connected to the Internet 304 runs the blockchain that forms a decentralized network, also known as nodes in blockchain terminology. These nodes are responsible for maintaining and updating the blockchain ledger, which in this case performs actions that record ownership, transactions, and contractual terms, and execute smart contracts for real estate properties.

When an asset owner 104 wants to tokenize their home 102, the asset owner submits the necessary documentation (such as a deed) to the tokenization system. The tokenization system receives a digital deed and performs functions using one or more forms of artificial intelligence, data processing, and cryptographic technologies.

The tokenization system receives a digital copy of the deed from the asset owner. This digital copy could be a scanned document or a photo of the physical deed. The tokenization system performs Optical Character Recognition (OCR), which can be a form of Artificial Intelligence (AI) that identifies text within digital images or scanned documents. The OCR module converts the visual representation of the text in the digital deed into machine-readable text.

Once the text has been recognized, a Natural Language Processing (NLP) module can be used to identify and extract key pieces of information. NLP, which can be another form of AI, is capable of understanding human language. In this case, the tokenization system identifies information such as the owner's name, the property description, boundaries, and any relevant legal language.

The extracted information is then standardized and stored in a structured database, enabling easy access and comparison. Standardization may involve transforming the text to conform to set formats, such as converting dates to a YYYY-MM-DD format, or geolocating addresses to standardized coordinates. Information, such as a digital copy of a deed, received from the various data sources can be of a different format.

In some cases, the machine learning model classifies the property based on the extracted information. The machine learning model identifies certain characteristics of the property that is not explicitly in the extracted information. For example, the machine learning model classifies a unit as a 1 bedroom based on its size and location.

The tokenization system configures data from multiple different databases that are in their own non-standardized format into a single standardized format. As such, messages can be automatically generated to communicate with individuals such as tenants and asset owners using the standardized format. Moreover, assessments and decisioning made by the tokenization system can be applied back to the asset owner by reapplying non-standardized formatting of the asset owner.

In some cases, the tokenization system processes the deed information into a viewable form, such as in a way which mirrors the physical representation of an original paper form of the deed. This reduces the time consuming nature of importing source code into the form. The tokenization system converts a digital copy of the deed into a standardized form which establishes calculations and rule conditions required to fill in the standardized form, import data from the digital copy to populate data fields in the standardized form, and performs calculations on the imported data. This allows the tokenization system to change imported data into a standardized viewable form.

In some cases, the tokenization system applies such standardization on documents or data received and/or documents generated. The tokenization system generates a standardized form of a deed to enable the tokenization system to generate a viewable deed form. In some cases, the tokenization system generates contracts, such as between the tenant and the asset owner, to rent and purchase tokens. The tokenization system collects data related to the tenant, asset owner, and asset from various different sources and applies standardization to this data to populate fields of the generated documents (e.g., contracts).

In some cases, the machine learning model performs one or more features of the standardization described herein. In some cases, the machine learning model performs customizations and/or standardizations based on a user's preferences. For example, the user inputs preferences such as a particular language for translation, customization on classifications and associated parameters, non-linear transformation, and/or the like.

In some cases, the tokenization system cross-checks information from the deed against a government or public property database. The tokenization system accesses such data via an API (Application Programming Interface) to interface with the relevant public records databases, query the extracted details, and compare the results for verification purposes. This step ensures that the property details match the official records and that the person claiming ownership is indeed the legal owner.

In some cases, the tokenization system and/or machine learning model cross-checks such information from the deed using other third party database. For example, the tokenization system checks information using global positioning system (GPS) data to verify the location, accesses photographs or data of prior owners such as on social media to verify the interior design of the home, and/or assesses a live camera feed from an augmented reality device. For example, the live camera feed can include a walk through of the property and the machine learning model applies computer vision algorithms to the camera feed to identify characteristics of the home, such as door types, bedroom locations, size, and/or the like.

Once the ownership is verified, the tokenization system divides the property's value into multiple tokens, as per the value evaluated by the system or provided by the user. The property can be divided based on a ratio of the value of the real estate and the value for each token. These tokens represent fractional ownership in the property. The token ownership records, deed, and other relevant details are encrypted and stored on a blockchain. Each token transfer can be managed via a smart contract, ensuring that all transactions are secure, transparent, and immutable, and the tokens are made available for tenants to purchase.

In some cases, the tokenization system applies the API to perform a recordation on the property records database, such as a records database of a government entity. In some cases, the tokenization system records a lien on the property based on tokens minted for the property.

In some cases, the tokenization system creates internal property records. For example, the tokenization system uses these internal property records for a layer of protection (e.g., to prevent multiple entries). In some cases, the tokenization system creates an internal property record to not have to rely on public records and/or to rely on such internal records when public records are unavailable.

If the tenant becomes the full owner, the tokenization system facilitates the transfer of ownership. The tokenization system initiates a transaction via the API with the property records database, to record the new ownership, such as via a smart contract indicating full ownership. These operations are conducted securely due to the cryptographic principles of the underlying blockchain and/or tokenization technology.

In some cases, the features related to the deed and/or other features of the tokenization system applies a self-referential table. A self-referential table includes a database table where a foreign key references the primary key of the same table. The tokenization system, for example, applies such self-referential tables to track the ownership history of the tokens representing asset ownership.

Each token could be represented as a row in the table, with fields such as token_id (the primary key), current_owner, previous_owner, and originating_asset (or depositor). The previous_owner field could reference another row in the same table, indicating the previous owner of the token before the current token owner, forming a chain of ownership. Such fields can be recorded onto the digital ledger. The tokenization system uses the originating_asset to associate a token with other tokens minted by the same asset owner. Advantageously, this field helps for certain features of the tokenization system, such as exchangeability and fungibility.

When a token is transferred from one owner to another (e.g., from the asset owner to a tenant), the current_owner field of the token's row is updated with the new owner's ID. A new row is also added to the table, representing a new token owner. The previous_owner field of this new row points to the row representing the token that was just transferred, creating a link in the chain of ownership.

Moreover, the tokenization system tracks a history of ownership via the self-referential table through the previous_owner field. Starting from a row representing a token's current owner, and previous_owner fields that would lead to the previous token owners before the current owner, and so on, until a row is reached where previous_owner is null, indicating the original token issued to the asset owner. This traceability adds to the transparency and security of the system, as it provides a tamper-proof log of token ownership changes.

When tokens are resold back to the asset owner or moved to another property, a similar process to the token transfer can be followed. The current_owner of the affected tokens is updated, and new rows are added to represent the new token owners.

The self-referential tables can include a special row and/or column within the database that stores the pointers to the other portions of the same table or other tables. Instead of having to save the benefit characteristics for each of the transactions or individuals, the tokenization system includes an entry that refers to another portion of the table or other table with the corresponding information. Advantageously, the data stored in each of the databases can be reduced by calling a call function (e.g. a database pointer) when a certain data entry in another table is needed.

Thus, a tokenization system and/or client devices can perform functions of the tokenization system and have more flexibility in assessing large datasets, which previously required a large network throughput of data and high processing speed. Moreover, a self-referential table can enable more efficient storage and retrieval of larger sized data, faster searching of the asset ownership, token distribution, and/or the like; and more flexibility in configuring the database.

In some cases, the tokenization system includes the group of computers 302 and/or facilitates communication among the group of computers 302. The nodes in the network validate information, such as ownership, and if validated, the nodes initiate the token creation process. The value of the property is divided by the chosen token value to determine the number of tokens to be minted.

These digital tokens 106, representing fractional ownership of the property, are issued to the asset owner (such as a tenant 108), such as to the asset owner's virtual asset storage. The transaction of minting and assigning these tokens is recorded on the ledger.

The nodes (such as the blockchain nodes) also manage the buying, selling, and leasing of tokens. For instance, when a tenant wants to buy tokens from an owner, the tenant submits a transaction to the network. The nodes verify the transaction, make sure the tenant has sufficient funds, and transfer the tokens from the owner's virtual asset storage to the tenant's. Once the transaction is validated and confirmed by the network (e.g., via the nodes), the transaction is recorded on the blockchain.

If a tenant accrues enough tokens to fully own the property, the blockchain network facilitates the transfer of ownership. The nodes of the blockchain burn or delete the tokens and update the property's ownership status on the digital ledger. The nodes validate this transaction before recording it on the blockchain. The nodes facilitate transfer over of the deed to the tenant.

When an asset owner (homeowner) decides to tokenize their property, the tokenization system evaluates the property to determine its current market value. The homeowner then provides the system with the necessary documentation (such as a copy of the deed) to confirm ownership of the property.

This information is verified by the decentralized network of computers running the blockchain, such as by accessing real estate records of ownership and/or on its own ledger of real estate ownership records. Once the information has been verified and the property's value has been established, the system will proceed with the tokenization process.

The value of the property is divided by the chosen token value (e.g., if a $300,000 property is divided into tokens each worth $100,000, 3 tokens will be minted as described above). These tokens, representing fractional ownership of the property, are digitally minted on the blockchain and assigned to the homeowner's virtual asset storage.

If a new tenant moves in or a lease is renewed, the system adjusts the valuation, if the value of the property increases, a certain number of additional tokens are minted and provided to the asset owner and/or the token holders associated with the property.

The homeowner may request to the tokenization system a re-evaluation of the property's value at any point, such as after significant improvements or renovations (e.g., adding a pool). If the value has changed, the system could initiate a re-tokenization process. For instance, if the property's value has increased from $300,000 to $500,000 and the token value remains at $100,000, two additional tokens would be minted and assigned to the homeowner and/or the token holders. This re-tokenization is recorded on the digital ledger.

Tokenizing real estate assets allows for flexibility in buying, selling, and transferring the tokenized assets. Individuals can trade tokens on a peer-to-peer basis on the tokenization platform, which is supported by the blockchain network. If a tenant wishes to buy tokens, they can send a transaction request to another individual who owns the tokens. The nodes verify ownership of the token and payment, and facilitate the transfer of ownership for the token.

The buyer sends the agreed upon amount (often in a form of cryptocurrency or any acceptable payment method on the platform) to the seller. Upon confirmation of payment, a smart contract is executed that transfers the tokens from the seller's virtual asset storage to the buyer's wallet. This transaction is recorded and verified on the blockchain, providing an immutable record and ensuring transparency.

In some cases, a buyer can buy or sell tokens directly from/to the asset owner. The asset owner lists the tokens for sale on the platform (such as with the specified price). A buyer who wishes to buy these tokens sends a purchase request, pays the specified price, and receives the tokens upon confirmation of payment via a smart contract. The smart contract ensures payment is made and tokens are owned and transferred. The asset owner can also buy back the tokens from the tenant or another token holder using a similar process.

Blockchain technology's inherent transparency, security, and immutability make it well-suited for this kind of application. Each node in the network independently verifies every transaction and maintains a copy of the ledger, making the system highly resilient and reliable. This decentralization also ensures that no single entity has control over the network, increasing trust and participation in the system using technological advances that are not typically used in real estate, let alone real estate ownership scenarios.

Intermediaries such as property developers or token aggregators could hold a pool of tokens from various properties and offer them for sale to interested buyers. The intermediary can list the tokens for sale on the platform, and buyers can purchase these tokens.

Intermediaries also can buy tokens. For instance, a token aggregator might be interested in buying tokens from various individual holders to add to their collection. Individual token holders or asset owners could sell their tokens to these intermediaries following a similar transaction process as described herein.

In these scenarios, the use of smart contracts ensures that transactions are securely executed and recorded. The blockchain's decentralized nature ensures transparency, as all transactions are visible to all participants in the network.

In some cases, the tokenization system and/or a smart contract can facilitate the use of a property. For example, a tenant can be renting a home while obtaining tokens. The tokenization system can facilitate such use by sending a message to control the property. The tokenization system sends a wireless message to a lockbox on the property enabling the user to access keys to open the home. In some cases, such messages can control the use, type of use, availability of certain operations and features, time period and duration of use, and/or the like using these communications.

The tokenization system sends such signals to a computing device or server of the asset, such as a vehicle computing device or a server communicating with one or more smart home systems.

In some cases, depending on the rules set by the platform, tokens are used across properties, meaning a token holder could potentially use their tokens as payment to rent or purchase in another property on the platform. These features make the tokens of the tokenization system truly fungible and provide additional flexibility to the token holders.

In the context of tokenizing real estate, leasing tokens introduces a level of flexibility and unique opportunities for temporary ownership and use of assets. The tokenization system enables a token holder who owns a certain percentage of an asset to lease tokens to another individual. By doing so, the tokenization system enacts a smart contract that enables the other individual to gain temporary ownership of the tokens and, by extension, the right to use or benefit from a proportion of the asset represented by these tokens.

During the lease period, the tokenization system enables the temporary token holder to rent the property to a tenant. The proceeds from the tenant are received by the tokenization system, whereby smart contracts are invoked to provide the proceeds to the token holder and the temporary token owner. At the end of the lease, the tokenization system invokes a smart contract whereby the tokens are automatically returned to the token owner's wallet.

The distribution of rent proceeds automatically disperse via smart contracts. For instance, if the rent is paid in cryptocurrency, the smart contract automatically distributes the rent to the token owner, the temporary token owner, and property manager based on predefined percentages. For example, the property manager may require a certain amount or percentage of the proceeds.

Token leasing in this manner not only provides opportunities for passive income for token holders but also increases liquidity of the token in the token market. It further allows those without the capital to purchase tokens outright to benefit from tokenized assets temporarily.

Token holders in a real estate tokenization system have various investment strategies at their disposal. The token holders can engage in arbitrage, where they buy and sell tokens to take advantage of price discrepancies across different markets or platforms, turning a profit from the difference in token prices. This might occur if tokens representing the same asset are priced differently in distinct markets.

Token holders can adopt a long-term investment strategy, holding onto tokens to benefit from natural appreciation of the underlying real estate asset. In some cases, over time, as the property value increases, so does the value of each token, providing capital gains to the token holders. In some cases, new tokens are minted and distributed to each owner accordingly, such as if there are multiple owners to a property management company or to multiple properties. Token holders can also deposit or lease their tokens to others, earning a passive income. This approach allows others to use the tokens temporarily, such as for rental income, while the original token holder continues to derive financial benefit.

In some cases, the asset owner divides the value of a single asset (say, a house) into several tokens. Each token represents a proportional stake in the returns from the asset (like rent). The tokenization system enables transfer of property ownership to a token holder who accumulates tokens equivalent to the asset's total value. In such a case, the tokens corresponding to that asset are removed from circulation or “purged.”

In some cases, the tokenization system enables an asset owner to have several assets (say, multiple properties). Here, the total value of all assets is divided into tokens, each representing a proportional stake in the returns from all assets. Alternatively, each individual asset can also have its own token representation. The tokenization system enables token holders to acquire ownership of an individual asset or a percentage of a group of assets by accumulating tokens equivalent to the asset's total value. In some cases, different owners of the same or different properties can each tokenize their equity and/or ownership.

This kind of tokenized asset ownership provides investors with a new way to diversify their portfolios and potentially lower barriers to entry in markets like real estate using the technological advances of tokenization.

Although examples described herein refer to asset or real estate property, it is appreciated that examples described herein can refer to other types of assets, including both physical and/or intangible assets. For example, assets can refer to vehicles, such as cars, boats, planes, and other vehicles, allowing investors to own a piece of these assets and potentially share in their appreciation over time.

In some cases, the assets refer to artwork and/or collectibles, such as paintings, sculptures, rare collectibles, and other valuable items that can be tokenized to enable broader ownership. This could lower the barriers to entry in the art investment market, which has traditionally been accessible only to the wealthy.

In some cases, assets refer to intellectual property, such as copyrights, patents, and other forms of intellectual property. This could enable creators to raise funds while allowing investors to share in the potential profits from these assets.

In some cases, assets refer to commodities such as gold, oil, or agricultural products, providing another way for investors to gain exposure to these markets. In some cases, assets refer to business equity, allowing investors to buy and sell tokens representing shares in the company. In some cases, assets refer to debt instruments, such as bonds or loans, which could create more flexibility and liquidity in the debt market. In some cases, assets refer to digital assets such as domain names, digital art (such as non-fungible tokens-NFTs), and in-game assets.

### Decentralized Protocol for Token-Based Resource Allocation

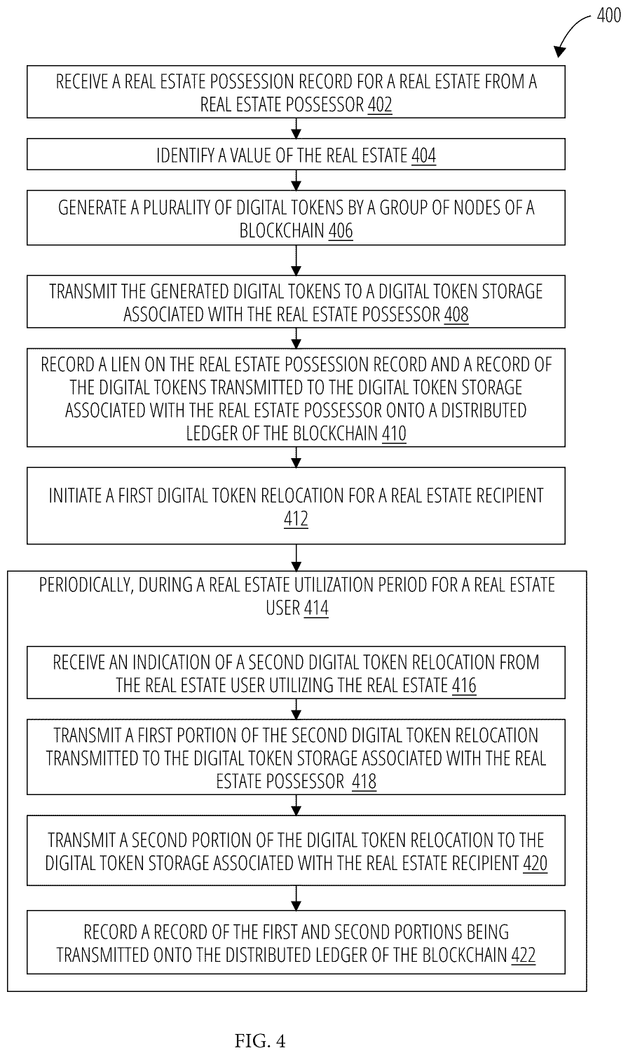

FIG. 4 illustrates an example method 400 for decentralized protocol for token-based resource allocation, according to some examples. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

At block 402, the tokenization system receives a real estate possession record for a real estate from a real estate possessor. The tokenization system acquires a digital representation of the legal rights associated with a real estate, provided by the individual or entity that currently holds those rights. The real estate can be any form of real-world property, such as real estate, vehicles, artwork, or other valuable goods.

In some cases, the real estate includes a real estate property, such as a home, a building, a car, equipment such as recording equipment, material such as gold or steel, technology such as a server or radio station, factories, production facilities, and/or the like. The real estate can include any real world object that can be divided based on its value, such as into tokens or digital tokens.

The real estate possession record includes a legal document that establishes the ownership and rights associated with the real estate. This could be a deed for a property, a title for a vehicle, or any other legal document that establishes ownership.

The process of digitizing this title involves taking a picture or scanning a physical copy of the real estate possession record. The tokenization system converts the information within the real estate possession record into a digital format that can be stored, transmitted, and processed electronically. In some cases, the tokenization system scans the real estate possession record and applies optical character recognition (OCR) to extract text.

The tokenization system can apply a machine learning model to map data fields in the real estate possession record to relevant data fields in the tokenization system database. In some cases, the tokenization system standardizes data in the real estate possession record. For example, formats and data can be different across different documents, such as abbreviations, acronyms, and/or formats (e.g., zipcodes). The tokenization system standardizes such data, such as using a machine learning model, in order to store and process the data.

With data in standardized format, the tokenization system can compare data to other data in its database. If the tokenization system desires to send data back to the computing system that transmitted the real estate possession record or other third party databases, the tokenization system converts the data into the non-standardized format of the receiving party.

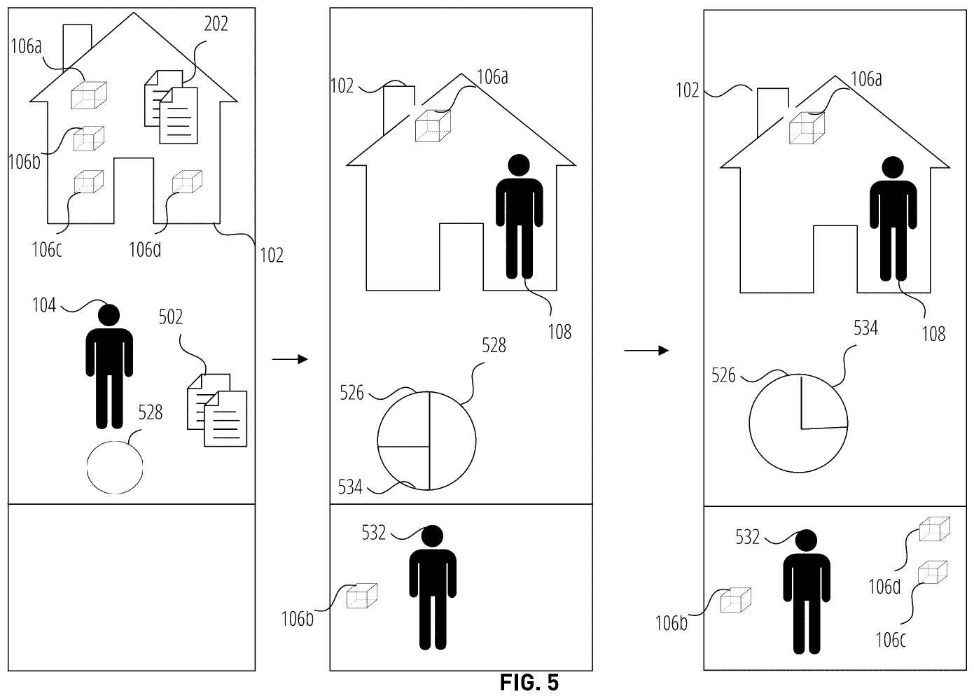

FIG. 5 illustrates an architectural diagram of tokenized returns, according to some examples. The real estate possessor 104 provides a real estate possession record (such as a deed 202) to the tokenization system.

At block 404, the tokenization system identifies a value of the real estate. The tokenization system determines a monetary worth of the real estate. The tokenization system determines the value of the real estate through one or a variety of ways. In some cases, the tokenization system determines the value of the real estate depending on the type of real estate. For instance, in the case of real estate, the value could be determined through a professional appraisal system, comparative market analysis, or valuation models.

In some cases, the tokenization system applies a valuation model, such as a machine learning model. The tokenization system inputs one or more characteristics of the property. The tokenization system identifies such characteristics based on information from the real estate possession record and/or third party databases. For example, the tokenization system can retrieve an address from the real estate possession record and retrieve characteristics of the property, such as the number of bedrooms, square footage, and/or the like from third party databases.

In some cases, the tokenization system trains and applies a machine learning model that can generate textual or visual descriptions of assets. In some cases, such a machine learning model is a transformer type machine learning model. The textual or visual descriptions can be searched using non-traditional queries. For example, a user can search “nice place in a gentrified neighborhood” or “apartment looks like the one in friends.” The machine learning model takes characteristics of the property from multiple different sources, such as google maps or a government database, to generate such textual or visual descriptions. In some cases, a user can draw an asset and the machine learning model, through its generated textual or visual descriptions, identifies the closest matching asset for the user.

In some cases, the tokenization system inputs characteristics of the real estate into the model, such as the condition, size, location, address, characteristics of the neighborhood, and other factors. The model is trained to identify similar properties (such as properties in a similar neighborhood that share certain characteristics of the real estate) and compares the property to these other similar properties that have recently sold in the same area to determine its estimated market value. In some cases, the machine learning model outputs such characteristics as described herein based on other characteristic inputs.

In some cases, the valuation models use mathematical modeling combined with databases of existing properties and transactions to calculate property values. These models can quickly provide an estimate of a property's value based on available data. This value serves as the basis for generating the digital tokens that represent ownership of the real estate. This value is also used by the tokenization system, machine learning models, and/or smart contracts in accepting transactions if the value is within an acceptable range of values.

At block 406, the tokenization system generates a plurality of digital tokens by a group of nodes of a blockchain. In some cases, the number of the generated plurality of digital tokens is based on the value of the real estate based on the value and a value for each digital token. In some cases, each digital token representing a fractional ownership interest in the real estate.

The tokenization system creates (or mints) digital tokens that represent fractional ownership in the real estate. These digital tokens are generated in a quantity that corresponds to the previously determined value of the real estate.

The tokenization system identifies a value for each digital token. The tokenization system can set the price of each digital token. The price can be set by a user such as the real estate possessor, and/or the price can be set by the market (such as based on buy and sell orders on an exchange that exchanges digital tokens for other monetary value such as money). The digital token price can be a standard value across all physical properties, and/or it could vary based on factors such as the type of real estate, the total value of the real estate, or market conditions.

Once the value per digital token is identified, the system determines the number of digital tokens to be generated that corresponds to the value of the real estate. For example, the tokenization system divides the total value of the real estate by the value of each digital token. For example, if a property is worth $100,000 and each digital token is worth $100, the system would generate 1,000 digital tokens. In another example, three digital tokens, such as digital tokens 106a, 106b, 106c, and 106d, are considered equal value to the home, and the digital tokens 106 of FIG. 5 are generated by the tokenization system.

Each of these digital tokens represents a fractional ownership interest in the real estate. For instance, in the above example, each digital token would represent a 0.1% ownership interest in the property.

The tokenization system can initiate a distributed ledger and/or blockchain technology to generate the digital tokens. The tokenization system initiates the blockchain to create unique, non-fungible digital tokens that can be securely tracked and transferred. Each digital token is a digital asset that is stored on the blockchain, providing a transparent and immutable record of ownership.

Once generated, these digital tokens can be bought, sold, leased, or traded, allowing for the fractionalization of ownership in the real estate. This enables individuals to invest in expensive physical properties such as real estate without needing to purchase the entire real estate outright or having to make a large down payment and sign onto a mortgage. The tokenization system also provides a mechanism for transferring ownership of the real estate over time, as individuals can gradually acquire digital tokens until they own a majority or the entirety of the digital tokens associated with the real estate.

In some cases, the asset owner places restrictions on the tenant, and/or vice versa. For example, the asset owner can place restrictions on purchasing, selling or leasing tokens by a tenant. In another example, only an individual under a usage contract can purchase tokens and they cannot sell them while under contract.

At block 408, the tokenization system transmits the generated digital tokens to a digital token storage associated with the real estate possessor. In some cases, the digital token storage includes a software-based system that securely stores users' digital assets, such as cryptocurrencies and/or asset-backed digital tokens.

The tokenization system initiates the transmission process once the digital tokens have been generated. The tokenization system initiates a transaction on the blockchain network to move the tokens from the system's wallet (or a temporary holding wallet) to the real estate possessor's wallet.

The tokenization system initiates the creation of a digital signature using its private key, which is then broadcasted to the blockchain network. The network's nodes validate the transaction, ensuring that the tokenization system has the necessary balance of digital tokens to perform the transaction and that the digital signature matches the system's public key.

Once validated, the transaction is added to a block of transactions, which is then added to the blockchain. This process ensures the immutability and transparency of the transaction, providing a clear record of the transfer of digital tokens from the system to the real estate possessor.

The real estate possessor's digital token storage will then update to reflect the receipt of the new digital tokens. The real estate possessor then manages these digital tokens within their wallet, including transferring them to other wallets or using them in transactions.

At block 410, the tokenization system records a lien on the real estate possession record and a record of the digital tokens transmitted to the digital token storage associated with the real estate possessor onto a distributed ledger of the blockchain.

Integration with land record databases—The system could interface directly with public land records to submit lien documents for recording and retrieve confirmation. In some cases, the tokenization system implements self-executing smart contracts that automatically notifies relevant third party databases that have their own record (such as records of liens and ownerships), transfer lien-related assets, and/or record the lien on the blockchain upon meeting coded conditions.

In some cases, the tokenization system applies IoT sensors, such as sensors on deed documents that could track their physical location and confirm when they are processed by the registrar's office. In some cases, the tokenization system applies computer vision algorithms, such as scanning deed documents and verifying registrar stamps and signatures using OCR and image analysis to validate recording (such as lien recording). In some cases, the tokenization system applies web scrapers to scrap public land record sites to check for lien recording and confirm registration details.

In some cases, the tokenization system applies Application Programming Interfaces (API) that interface with registrar's office databases, and submit via API lien data and retrieve recording confirmation of lien recordation programmatically. In some cases, the tokenization records the lien on a distributed ledger, such as recording the lien cryptographically on a blockchain to decentralized ledger.

At block 412, the tokenization system initiates a first digital token relocation for a real estate recipient. The first digital token relocation transmit a first subset of digital tokens from the digital token storage associated with the real estate possessor to a digital token storage associated with the real estate recipient and recording the transmission of the first subset onto the distributed ledger.

The tokenization system identifies that a partial real estate asset transfer is taking place from a possessor (current owner) to a recipient (new owner). The system looks up the digital token storage wallet/account associated with the real estate possessor. This contains the total supply of tokens representing ownership of the real estate asset.

The tokenization system calculates the first subset of tokens that need to be transferred to the recipient based on the details of the real estate transfer agreement. For example, if the recipient is purchasing 50% ownership of the property, the system will calculate 50% of the total tokens. The system initiates an automated transfer of the calculated first subset of tokens from the possessor's digital token storage to the recipient's digital token storage.

In some cases, the unique identifiers of the tokens being transferred, the sending and receiving wallets, and the transfer details are immutably recorded on the distributed ledger. The ledger entry confirms that the possessor's storage now has a reduced number of tokens, while the recipient's storage has a corresponding increased balance. The recorded transaction officially verifies the transfer of ownership stake (as represented by the transferred tokens) from the possessor to the recipient.

In some cases, the tokenization system receives a restriction on digital token relocations for real estate recipients. In some cases, the restriction comprises a time period for submitting digital token relocations by real estate recipients or a required value for the digital token relocations submitted by real estate recipients.

In some cases, the restrictions include a restriction that real estate tokens cannot be transferred for the first a number of months after issuance, real estate tokens can only be transferred if the total value of tokens being transferred is at least a certain amount, real estate token transfers are only allowed during a specific time period each term (such as 2 weeks a year), real estate tokens can only be transferred to recipients who have been pre-approved by the tokenization system, and/or the like.

In some examples, the tokenization system applies a machine learning model to receive an expected return for digital token relocations submitted by real estate recipients over a period of time. The tokenization system collects data on factors that impact real estate token values such as market conditions, property attributes, location, demand, etc. This data is inputted into a machine learning algorithm that is trained to analyze the relationships between the variables. The model looks at patterns in the data to make predictions about how real estate token values will change in the future.

When a real estate token recipient submits a request to transfer tokens, the system can run the request details through the trained machine learning model. The model will analyze the property details, recipient details, and external factors to generate a customized prediction for the expected return on those tokens over the recipient's defined time period. This provides useful insights to the recipient on the potential appreciation or depreciation of the real estate tokens over time. The machine learning model can be continuously refined as new data comes in, improving its ability to forecast real estate token returns.

At block 414, the tokenization system performs certain steps periodically, during a real estate utilization period for a real estate user, such as blocks 416, 418, 420, and/or 422. At block 416, the tokenization system receives an indication of a second digital token relocation from the real estate user utilizing the real estate.

The tokenization system periodically receives signals or notifications of digital token relocations from the real estate user during a specified period of real estate use. The real estate user could be a tenant, a renter, or any other party who is using the real estate but does not fully own it.

The tokenization system can receive digital token relocations that can relate to one or more different actions related to the use or partial acquisition of the real estate. For instance, the tokenization system receives an indication of a rent payment, a purchase of additional digital tokens representing ownership in the real estate, or the like. In some cases, the tokenization system determines such payment is made from a third party financial database or server. In other cases, the payment is made directly to the tokenization system.

In some cases, the tokenization system receives token resource allocations for insurance payments, tax refunds, and/or other forms of payment. For example, if insurance payments were also made by the tenant, a smart contract initiates payment back to the home owner and tenant according to their proportional ownership.

The tokenization system receives the indication of the digital token relocation via digital signal or message sent from the real estate user's digital token storage or account to the system. The indication includes information about the transaction, such as the amount paid, the number of digital tokens purchased, and the time of the transaction.

The tokenization system receives this indication and processes it to update the records of the real estate and the associated digital tokens. The tokenization system updates the balance of digital tokens in the real estate user's digital token storage, updating the remaining value of the real estate, and/or updating the record of payments made by the real estate user.

The tokenization system identifies that a fractional real estate asset transfer is taking place from a possessor (current owner) to a recipient (new owner). The system looks up the digital token storage wallet/account associated with the real estate possessor. This contains the total supply of tokens representing ownership of the real estate asset.

The tokenization system calculates the first subset of tokens that need to be transferred to the recipient based on the details of the digital token relocation. For example, if the recipient is purchasing 50% ownership of the property, the system will calculate 50% of the total tokens.

The system initiates an automated transfer of the calculated first subset of tokens from the possessor's digital token storage to the recipient's digital token storage. The unique identifiers of the tokens being transferred, the sending and receiving wallets, and the transfer details are immutably recorded on the distributed ledger.

The ledger entry confirms that the possessor's storage now has a reduced number of tokens, while the recipient's storage has a corresponding increased balance. The recorded transaction officially verifies the transfer of ownership stake (as represented by the transferred tokens) from the possessor to the recipient. The system cross-checks the token transfer against the token relocation to ensure accuracy.

At block 418, the tokenization system transmits a first portion of the second digital token relocation transmitted to the digital token storage associated with the real estate possessor. This first portion can represent a variety of things depending on the specifics of the transaction and the terms of the real estate use. For instance, in a rental scenario, the first portion represents the part of the tenant's payment that is allocated to rent to the real estate possessor.

The tokenization system transmits the first portion of the digital token relocation to the real estate possessor. In some cases, tokenization system identifies a payment made through other channels, such as assessing a financial transaction from the real estate user to the real estate possessor.

The tokenization system identifies this first portion by analyzing the details of the transaction indication received from the real estate user. This could involve parsing the transaction data, applying predefined rules or algorithms, or using machine learning models to classify and quantify the different parts of the transaction.

Once the first portion is identified, the payment is recorded in the system and used to update the records of the real estate and the associated digital tokens. This involves subtracting the value of the first portion from the digital token relocation.

At block 420, the tokenization system transmits a second portion of the digital token relocation to the digital token storage associated with the real estate recipient. The first and second portions being based on digital tokens stored in digital token storage of the real estate possessor and the real estate recipient.

The second portion represents a portion of the digital token relocation, such as the rent payment, that is distributed to the other token holders, such as to the physical property occupant or the real estate recipient. For example, during the real estate utilization period for the real estate by the real estate user, the real estate user acquires digital tokens and becomes a gradual owner of the real estate. Due to the partial ownership of the real estate, the real estate user also acquires a portion of the proceeds, such as the rent received. The token purchase and partial ownership applies for the real estate recipient.

At block 422, the tokenization system records a record of the first and second portions being transmitted onto the distributed ledger of the blockchain. The distributed ledger on the blockchain maintains a decentralized, immutable record of all tokenization system transactions.

When the first subset of tokens is transferred from the possessor to the recipient, the details of this transfer are recorded on the ledger. This includes the sending and receiving wallets, number of tokens, timestamp, etc. This ledger entry documents the change in token balances resulting from the first transfer portion. The possessor's balance is verifiably decreased, and the recipient's balance increased.

When the second subset of tokens is subsequently transferred, the details of this second transfer are also immutably recorded on the ledger. The ledger now reflects the updated token balances of both parties following the second transfer action. Recording the first and second portions provides a transparent, undisputed record of the continuing asset ownership changes enacted through the token transfers.

In some cases, the first and second portions are determined based on a number of digital tokens in associated electronic token data repositories. For example, as shown in FIG. 5, the real estate (such as a home 102) has value equivalent to 4 digital tokens 106a, 106b, 106c, and 106d. The digital token storage of the real estate possessor 104 initially receives all 4 tokens. At this point, all digital token allocations 528 (e.g., proceeds), from the real estate is returned to the real estate possessor.

Over time, the real estate recipient 532 or user (e.g., tenant 108) acquires tokens. For example, the recipient and the tenant 108 each acquire one digital token 106a and 106b, and is now a ¼ owner of the home. At this point, digital token allocations are divided into a first portion 528 corresponding to the real estate possessor and a second portion 526 corresponding to the real estate recipient and a third portion 534 corresponding to the real estate user. For example, if the rent payment was $2000, at this point, $500 would be returned back to the real estate user, $500 to the recipient, and $1000 would be sent to the real estate possessor.

In some cases, the digital token relocation required for occupancy is reduced, instead of the full amount being received and distributed back. For example, if the physical property occupant is now a ¼ owner, a usual rent payment of $2000 is reduced to $1500 and the remaining $1500 is sent to the other token holders.

As shown in FIG. 5, as the real estate recipient increases ownership of the property (e.g., now owns tokens 106b, 106c, 106d), the second portion 526 of the digital token relocation corresponding to the real estate recipient is far greater than the second portion 534 corresponding to the real estate user. The real estate possessor is no longer the owner, or no longer owns any part of the home 102.

In some cases, another portion is allowed to costs, such as to property management, expenses, utilities, and/or the like. In some examples, a portion of the digital token relocation is sent to the property manager. If the real estate possessor is the property manager, the tokenization system sends the portion of the digital token relocation for rent and for property management to the real estate possessor. If the property manager is a third party, the tokenization system sends separate payments to the property manager and to the asset owner.

In some cases, the tokenization system determines a number of digital tokens corresponding to a third portion of the digital token relocation based on the first portion and the second portion. The tokenization system determines a number of digital tokens corresponding to a third portion of the digital token relocation based on the first and second portion. The third portion of the digital token relocation can represent the part of the payment that is allocated to the purchase of digital tokens, which represent fractional ownership in the real estate.

The tokenization system determines the number of digital tokens corresponding to the third portion by dividing the value of the third portion by the value of each digital token. For example, if the third portion of the payment is $1000 and each digital token is worth $100, the system would determine that the third portion corresponds to 10 digital tokens.

In some cases, the tokenization system transfers the number of digital tokens corresponding to the third portion from the digital token storage of the real estate possessor to a digital token storage of the real estate user.

The tokenization system transfers the number of digital tokens corresponding to the third portion from the digital token storage of the real estate possessor to a digital token storage of the real estate user. The tokenization system facilitates the transfer of a specific number of digital tokens from the digital token storage of the real estate possessor to the digital token storage of the real estate user.

In some cases, the transfer process begins with the tokenization system initiating a transaction on the blockchain network. This transaction involves moving the specified number of digital tokens from the real estate possessor's wallet to the real estate user's wallet. The tokenization system creates a digital signature for the transaction using the private key associated with the real estate possessor's wallet. This signature is then broadcasted to the blockchain network, where it is validated by the network's nodes. The nodes check that the real estate possessor's wallet has a sufficient balance of digital tokens and that the digital signature matches the public key associated with the wallet.

Once validated, the transaction is added to a block of transactions, which is then added to the blockchain. This process ensures the immutability and transparency of the transaction, providing a clear record of the transfer of digital tokens from the real estate possessor to the real estate user.

In some cases, in response to a lapse of the real estate use period for the real estate user, the tokenization system determines whether the quantity of digital tokens within the digital token storage of the real estate user equals or exceeds the number of digital tokens corresponding to the value of the real estate. In response to determining that the quantity of digital tokens within the digital token storage of the real estate user does not equal or exceed the number of digital tokens corresponding to the value of the real estate, the tokenization system renews the real estate use period.

In some cases, the tokenization system automatically renews the real estate utilization period. In other cases, the tokenization system generates a new contract to be agreed upon between the asset owner and the tenant for a new real estate utilization period.

The real estate use period can include a predefined time period, such as a lease term or a use term, during which the real estate user is expected to acquire full or partial usage rights, and full and/or partial ownership of the real estate by purchasing digital tokens.

The tokenization system retrieves the current balance of digital tokens in the real estate user's digital token storage and compares it to the total number of digital tokens that correspond to the full value of the real estate.

If the system determines that the balance of digital tokens in the real estate user's wallet does not equal or exceed the total number of digital tokens, the tokenization system determines that the real estate user has not yet acquired full ownership of the real estate. In this case, the tokenization system renews the real estate use period, allowing the real estate user more time to acquire the remaining digital tokens.

The renewal of the real estate use period involves extending the lease term, renewing the loan term, and/or setting a new deadline for the real estate user to acquire full ownership. This provides flexibility for the real estate user and allows them to continue using the real estate and acquiring digital tokens to full ownership.

In some cases, the tokenization system determines that a quantity of digital tokens within the digital token storage of the real estate user meets or exceeds the number of digital tokens corresponding to the value of the real estate. The tokenization system checks the balance of digital tokens in the real estate user's digital token storage and compares the amount to the total number of digital tokens that correspond to the full value of the real estate.

The tokenization system retrieves the current balance of digital tokens in the real estate user's digital token storage. In the case where a distributed ledger is used, the tokenization system queries the blockchain network for the wallet's address and retrieving the associated balance. The tokenization system compares this balance to the total number of digital tokens that were initially generated to represent the full value of the real estate.

In some cases, the tokenization system reassesses a total number of digital tokens based on the current price of the real estate. For example, the real estate appreciates (or depreciates) naturally over time. In some cases, modifications or damage occurs to the real estate over time, and thus the value appreciates or depreciates.

If the balance of digital tokens in the real estate user's wallet equals or exceeds the total number of digital tokens, the tokenization system determines that the real estate user has acquired full ownership of the real estate. This could be the result of the real estate user gradually purchasing tokens over time, or of one or more large transactions in which the real estate user purchases some or all of the required digital tokens.

In some cases, the full ownership occurs automatically when balance of tokens in the real estate user's wallet equals or exceeds the total number of tokens. In some cases, the real estate user is provided the option to acquire the asset upon reaching the required number of tokens.

In some cases, the tokenization system transfers and/or records the real estate possession record for the real estate to the real estate user. The transferring indicates full ownership of the real estate by the real estate user.

This transfer is triggered when the tokenization system determines that the quantity of digital tokens in the real estate user's digital token storage equals or exceeds the total number of digital tokens corresponding to the full value of the real estate, indicating that the real estate user has acquired full ownership.

The real estate possession record includes a digital version of a deed, title, or other legal document that establishes ownership of the real estate. This document is stored in a secure, tamper-proof format of the tokenization system, such as a blockchain or a secure database.

The tokenization system initiates the transfer by creating a transaction on the blockchain or updating the database to reflect the change in ownership. The tokenization system can change the owner field in the real estate possession record to the identifier of the real estate user, or creating a new real estate possession record with the real estate user as the owner and invalidating the previous document.

The tokenization system initiates broadcasting of the transaction or update to the network or commits the change to the database, where it is validated and recorded. This process ensures the immutability and transparency of the ownership transfer, providing a clear and indisputable record of the real estate user's ownership.

Once the transfer is complete, the real estate user has full legal ownership of the real estate, as represented by the real estate possession record. The real estate user becomes the new real estate possessor and can exercise all rights and privileges associated with ownership, such as selling the real estate, using it as collateral, or making modifications to the real estate. Moreover, the real estate user, now as the new real estate possessor, can offer a similar schema of tokenizing the property and enabling a new tenant to rent and purchase equity progressively, as further described herein.

In some cases, the tokenization system determines that a quantity of digital tokens of the real estate user is less than the number of digital tokens for the value of the real estate. The tokenization system records the real estate possession record for the real estate back to the real estate possessor. For example, the tokenization system records a lien on the deed in exchange for the digital tokens. The tokenization system releases the lien such that the real estate possessor 104 now owns the real estate free from the recorded lien.

In some cases, upon termination of the property utilization, the tokenization system determines that the real estate user does not have enough digital tokens for full ownership of the real estate. The tokenization system can provide an option for the real estate possessor to purchase back the digital tokens from the real estate user, such as based on a market value. The repurchasing of the digital tokens can be compulsory for the real estate user, for the real estate possessor, and/or both.

In some cases, the tokenization system receives an indication of a third digital token relocation. In response to receiving the indication of the third digital token relocation, the tokenization system transmits the first subset of digital tokens from the digital token storage associated with the first real estate recipient to the digital token storage associated with the real estate possessor.

Further in response to receiving the indication of the third digital token relocation: the tokenization system transmits digital tokens stored in the digital token storage associated with the real estate user to the digital token storage associated with the real estate possessor and removes the lien on the first real estate possession record. In some cases, the tokenization system records a modified first real estate possession record that removes the lien or generates a new first real estate possession record without the lien.

### Asset Right of Use, Fractional Ownership, and Ownership

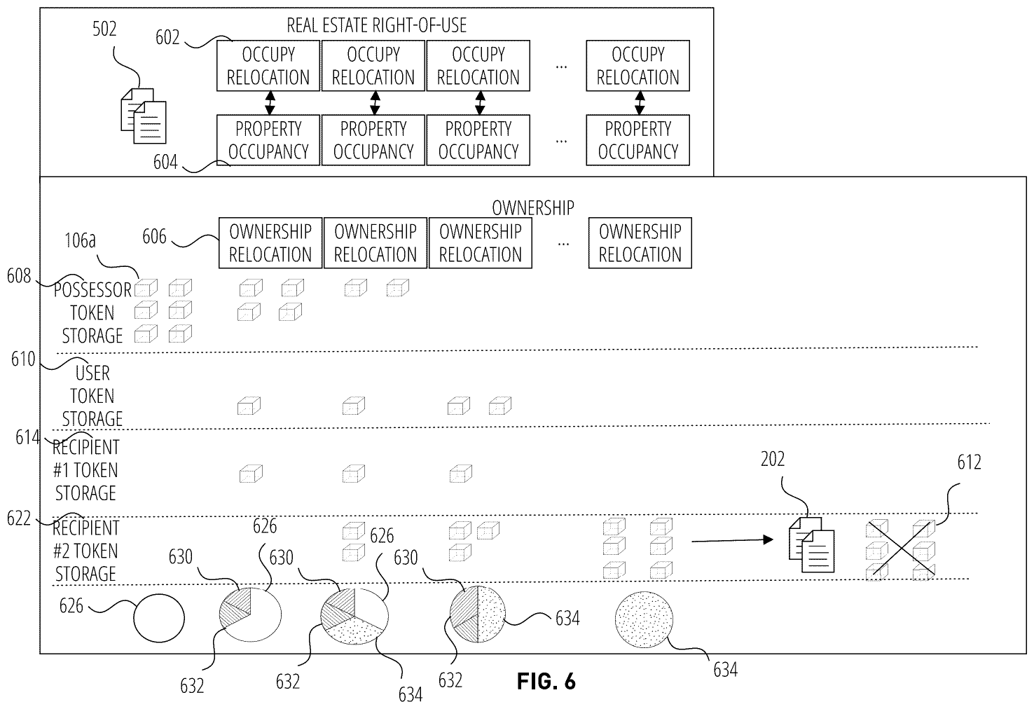

FIG. 6 illustrates an example architecture for the right of use, fractional ownership, and ownership of an asset, according to some examples. The real estate possessor provides a digitized asset rights document 502, such as a deed, to the tokenization system.

Subsequently to the tokenization system receiving the digitized asset rights document, the tokenization system identifies a value of the real estate. This could involve using data from the asset rights document, such as the purchase price or the assessed value, obtaining an independent appraisal, and/or performing market analysis (e.g., using models such as machine learning models).

The system then generates a plurality of digital tokens, such as token 106a corresponding to the value of the real estate. Each token represents a fractional ownership interest in the asset. The number of tokens is determined by dividing the value of the asset by the value of each token. Once the tokens are generated, the tokenization system transmits the tokens to a real estate possessor's digital token storage 608.

In some cases, the real estate user, such as a tenant, submits a occupy exchange 602 to the system. This transaction enables the tenant's property occupancy 604. The occupy exchange could include various details, such as the amount of the payment, the period of time for which the payment covers the use of the asset, and the specific portion of the asset that the tenant is paying to use. For example, the tenant could be paying to use the whole house, a specific room, or the asset during a specific period of time.

In some cases, the tokenization system automatically enables access to the asset. For example, the tokenization system automatically configures digital locks or security systems. In some cases, the tokenization system generates a unique access code for the real estate user upon receipt of the occupy exchange. The tokenization system sends the real estate user this code, allowing them to access the property.

In some cases, the tokenization system uses smart contracts on the blockchain to automatically grant access rights to the real estate user. The smart contract is programmed to change the status of the asset to ‘in use’ by the real estate user upon receipt of the occupy exchange. Such a status initiates (and/or the smart contract initiates configuration of) proper technology, as described herein, to enable access to the property.

In some cases, the tokenization system configures Internet of Things (IoT) devices that are connected to the asset. The tokenization system sends commands to these devices to grant access to the real estate user. For example, the tokenization system sends a command to unlock the doors of a rental property or to activate utilities of a car.

For assets such as rental properties or shared spaces, the tokenization system integrates with existing reservation platforms. Upon receipt of the use occupy exchange, the tokenization system automatically books the property for the real estate user for the agreed-upon period.

In some cases, the tokenization system generates legal documents, such as lease agreements, that grant the real estate user the right to use the property. In some cases, the tokenization system generates such documents by identifying relevant data fields and populating the fields with information retrieved. The tokenization system applies the standardized data (as described further herein) to the forms to generate legal documents for the parties to sign.

In some cases, the tokenization system applies a machine learning model to generate such legal documents. The machine learning model is trained to receive information related to the asset, the real estate possessor, and/or the real estate user, and generate legal documents, based on training on historical asset, real estate possessor, and real estate user data.

Although the machine learning model is described to perform certain steps herein, it is appreciated that the machine learning model can facilitate and/or perform one or more features of the tokenization system, such as asset valuation, generation of tokens, transmitting of tokens from one wallet to another, providing usage to an asset user, and/or the like.

In addition to the occupy exchange, the real estate user can also choose to purchase tokens that represent equity in the asset in an ownership exchange 606. This could be done at the same time as the occupy exchange, or it could be done separately. Such ownership exchange 606 can occur as a separate transaction or in the same transaction as the occupy exchange 602. The number of tokens that the tenant purchases is determined by the amount of monetary value the tenant applies divided by the token value. In some cases, one or more real estate recipients can also submit ownership relocations. For example, if each token is worth $100 and the recipient chooses to put $100 towards equity, then as shown in FIG. 6, one token is transferred from the real estate possessor digital token storage 608 to the real estate recipient #1 digital token storage 614 and recipient #2 digital token storage 622. The proceeds from the real estate were previously sent only to the possessor token storage as the possessor's ownership 626 was 100%. Now the proceeds are distributed among the first recipient, the user, and the possessor, because the possessor's ownership 626 is 4/6ths, the first recipient's ownership 632 is ⅙, and the user's ownership 630 is ⅙.

After the second token relocations, the second recipient gains 2 tokens. The second recipient gains 2 tokens from the possessor. In some cases, the recipients can receive tokens from the user or other recipients into the recipient #2token storage 622. Now the proceeds are distributed among two recipients, the user, and the possessor, because the possessor's ownership 626 is 2/6ths, the first recipient's ownership 632 is ⅙, the second recipient's ownership 634 is ⅓, and the user's ownership 630 is ⅙.

The system processes the occupy exchange and the token purchase by updating the blockchain or the database to reflect the new token ownership. This could involve the blockchain debiting the tenant's account for the amount of the occupy exchange and the token purchase, crediting the real estate possessor's account for the property occupancy, debiting the real estate possessor's digital token storage of one token, and crediting the real estate user's digital token storage of the one token.

In some cases, the real estate user does not have the ability to sell tokens purchased through the ownership exchanges during pendency of use. In other cases, the real estate user has the ability to exchange the tokens for other things of monetary value, such as money. The real estate user can sell the tokens back to the real estate possessor and/or on the open market. Upon sale of the tokens, other third parties can own the tokens. In some cases, these third parties now are fractional owners of the real estate. In other cases, these third parties instead are owners of equity that can be applied to other similar tangible properties.

In some cases, because the real estate user is a progressive owner of the real estate over time, the proceeds can either be returned to the real estate user and/or the required digital token relocation can be reduced. For example, the real estate can be valued at 6 tokens, such as including token 106a. As such, in the beginning, the portion of the proceeds that are provided to the physical property owner's token repository 608 is 100%.

After the first digital token relocation, each real estate recipient now owns 1 token, stored in the property occupant's token repository, and the real estate possessor now only owns 4 tokens. If the real estate user were to hold tokens, a portion of the proceeds is either returned to the property user token repository 610 and/or reduced from the amount required for occupancy of the real estate. At this time, only a first portion 626 is provided to the property owner.

As time progresses, the property recipient #2 owns all 6 tokens and now the proceeds are transmitted only to the second recipient token storage 622 because of full ownership portion 634 by the second recipient. In some cases, the property occupant owns all tokens, and as such, the entire token exchange is returned to the property occupant and/or a digital token relocation is not required (except possibly for property maintenance and/or other costs) for the real estate user to use the property.

The tokenization system determines that the real estate user has sufficient tokens to gain ownership of the home by comparing the quantity of digital tokens within the real estate user's digital token storage to the number of digital tokens corresponding to the value of the real estate. Upon determining that the real estate user has sufficient tokens, the tokenization system initiates the transfer of ownership.

In some cases, the tokenization system updates the digitized asset rights document, such as a deed or title, to reflect the real estate user as the new owner. The tokenization system creates a new digitized asset rights document with the real estate user's name and invalidating the previous document, or by updating the owner field in the existing document. The updated asset rights document is then recorded on the blockchain or in the database, providing a clear and indisputable record of the real estate user's ownership.

In some cases, the tokenization system leaves the tokens in the real estate user digital token storage. In other cases, the tokenization system purges 612 the tokens from circulation. If the tokenization system keeps the tokens in the real estate user digital token storage, the real estate user can use them to rent the asset to another tenant, effectively becoming the new real estate possessor. If the tokens are purged, the tokenization system removes the tokens from the real estate user's digital token storage and updates the blockchain or database to reflect the reduced supply of tokens. Advantageously, purging of the coins prevents the real estate user from selling the property using the tokens and/or selling the property separately using the asset ownership document.

In some cases, the real estate user can determine an amount of tokens remaining until full ownership and make a full transaction to own the required tokens. For example, in the middle of the real estate utilization period, the real estate user owns 4 tokens but needs 6 more for full ownership. The real estate user can initiate a transaction to purchase all 6 tokens. The tokenization system can then initiate completion of asset ownership transfer at that time. Similar features apply for the token recipient.

Examples described herein are described according to one real world property. However, it is appreciated that the examples and features can apply to a collection of assets, such as a portfolio of properties owned by a developer or a real estate company. In this case, the “real estate” referred to herein include multiple individual assets, each of which could be a separate property. For example, the assets can be equivalent to a certain set amount of tokens. In other examples, the assets acquire tokens based on the value of the individual asset (e.g., the tokens are set to a particular price, and the tokens given to an individual asset is based on the number of tokens equivalent to the asset value).

The real estate possessor provides digitized asset rights documents for each property in the collection. The system identifies the total value of the collection of properties. The system generates digital tokens corresponding to the total value of the collection of assets. Each token represents a fractional ownership interest in the entire collection, not just a single property. Thus, a real estate user who purchases tokens is gaining equity in the entire collection of properties, not just one property.

The real estate user is able to use one of the tangible properties in the collection, such as by renting a property. The system checks whether the quantity of tokens in the real estate user's digital token storage equals or exceeds the number of tokens corresponding to the value of the collection of assets. If it does, the tokenization system transfers full ownership to the collection of properties to the real estate user. The system transfers the digitized asset rights documents for the entire collection of assets to the real estate user.

This approach allows a developer or real estate company to tokenize a portfolio of properties and sell fractional ownership interests to multiple real estate users. It provides a flexible and efficient way for real estate users to gain equity in a collection of properties, and it allows the real estate possessor to raise capital by selling tokens.

The system ensures proper ownership exchange by maintaining a clear and immutable record of all transactions related to the asset, including the initial tokenization of the asset and all subsequent transfers of tokens. This record serves as a digital chain of title, providing a transparent history of the asset's ownership.

When the real estate possessor first submits the digitized asset rights document (such as a deed) to the system, the system records this transaction on the blockchain or in a secure database. This initial record includes the real estate possessor's identity, the value of the asset, and the number of tokens generated.

Each time tokens are transferred from one digital token storage to another, the system records the transaction. This includes transfers from the real estate possessor to the real estate user (such as a tenant), as well as any subsequent transfers between different real estate users. Each record includes the identities of the sender and receiver, the number of tokens transferred, and the time of the transfer.

When the quantity of tokens in the real estate user's digital token storage equals or exceeds the total number of tokens corresponding to the value of the asset, the system recognizes this as a transfer of ownership. In other cases, the system provides the option of transfer of ownership. The system updates the digitized asset rights document to reflect the real estate user as the new owner and records this transaction.

The system maintains a complete record of all these transactions, creating a digital chain of title for the asset. This chain of title provides a clear and indisputable history of the gradual change in asset's ownership as well as the final transfer of full ownership.

By maintaining this digital chain of title, the system ensures that the ownership transfer is transparent, secure, and legally valid. The blockchain technology used in this process provides additional security by making the record immutable, meaning it cannot be altered or deleted once it's been recorded. This prevents fraud and disputes over ownership, providing peace of mind for all parties involved.

In some cases, the tokenization system generates legal documents to formalize each transfer of ownership. For example, when the real estate user acquires enough tokens to become the owner, the system could generate a new deed or title in the real estate user's name for the real estate user and the real estate possessor to sign. This document would be legally binding and could be recorded with the appropriate government agency.

In some cases, the tokenization system applies a machine learning model that is trained to generate required documents for a particular property. For example, the machine learning model generates different documents for an apartment complex, a single family home, a commercial property, or for an automobile. In some cases, the machine learning model generates documents required for different jurisdictions, such as based on state law or documents needed for foreign jurisdictions.

In some cases, upon the real estate user acquiring enough tokens, the system uses a third-party escrow system to hold the digitized asset rights document and oversees the transfer of ownership. The escrow system ensures that the real estate user has enough tokens before transferring the document to them.

In some cases, the tokenization system uses digital signatures to authenticate each transaction. Both the sender and receiver of tokens signs each transaction (such as with their private keys), providing a secure and verifiable record of the transaction.

In some cases, the system integrates online notary systems to notarize the transfer of ownership. This would provide an additional layer of legal assurance that the transfer is valid.

In some cases, the system automatically records, such as at a government agency database, a change of ownership. For example, the government agency database can hold a chain of title for a real estate property. The tokenization system initiates transmission of a message to the government agency database for the recordation of the new ownership to add to the chain of title.

In some cases, the system creates a new token recordation system that replaces and/or augments a centralized database, such as a government agency database. This can be useful if government agency databases are not complete and/or if no database currently exists.

In some cases, the tokenization system applies a machine learning model to optimize various aspects of the tokenization system. In some cases, the tokenization system applies historical data to the machine learning model, such as historical real estate possession records, historical contracts between the owner and user of the real estate, and/or the like and trains the model to generate an optimal digital token relocation, such as an amount or value of the asset, and/or usage duration of the asset. The tokenization system uses the amount or value of the asset to verify a transaction as being within an acceptable range of the valuation.

The tokenization system trains a machine learning model using previous real estate contracts associated with different properties. Based on various factors such as property value, location, market conditions, historical trends, and more, the machine learning model is trained to estimate an optimal transaction amount and/or contract duration for a new property that's being tokenized.

For example, if the property is similar to previous assets, the machine learning model is trained from historical data to suggest terms based on an assessment of what happened for the previous assets. The machine learning model is trained to determine how quickly tokens were purchased for past property, any trends in token purchases, and so forth, to suggest a contract duration. Similarly, the machine learning model is trained to look at token prices in relation to the property value to suggest an optimal token price.

In some cases, the machine learning model is trained to perform one or more features of the tokenization system on assets that are non-similar. The machine learning model receives as input various characteristics of multiple properties, generate hidden latent variables across the different properties that factor into valuation, and applies such latent variables to compare properties that are dissimilar.

The tokenization system applies such models for the benefit of various entities. The tokenization system can help the real estate possessor in determining the parameters for their token offering. The tokenization system can help the tenant in evaluating different tokenization offers and finding the one that matches their financial capacity and goals. The tokenization system also applies such models to smart contracts to verify transaction by ensuring the values are within the range of values that the machine learning model estimates or outputs.

In some cases, the tokenization system trains a machine learning model by applying input lease agreements associated with different assets to determine the forecast expected total cost to a tenant for ownership and provide a comparison for different options.

The tokenization system trains a machine learning model to analyze past contracts and/or current market conditions to forecast a value a tenant could expect to submit over time to gain ownership of a property using the digital tokens. The machine learning model is also trained to compare this total value against other options, such as compared to traditional home buying or other tokenized processes.

The tokenization system trains a machine learning model to use various inputs such as the property's token price, the length of the contract, market trends, and other relevant data. The model can process this information to generate a projection of total value to be submitted and uses this forecast to compare different home ownership options. The tokenization system helps tenants make informed decisions about the most cost-effective way to gain homeownership.

In some cases, the tokenization system trains a machine learning model to review a smart contract and translate the contract into a form aligned with certain tenant specified criteria. Smart contracts include self-executing contracts with the terms of the agreement directly written into code. The smart contracts detail the terms of the tokenization agreement, including token price, number of tokens, contract duration, and/or the like.

The machine learning model receives the smart contract code as input and translate the code into a format that aligns with the tenant's specific criteria or requirements, such as reinterpreting the terms into a more readable format, highlighting key terms and conditions, or mapping terms to specific criteria set by the tenant.

As such, the tokenization system applies such a machine learning model to help tenants to quickly understand the terms of various tokenization contracts, and how they align with their specific needs and goals. It would make the process of comparing and choosing between different tokenization options more accessible and user-friendly.

In some cases, the tokenization system applies a machine learning model that receives as input previous asset valuations and a new asset valuation report. The machine learning model is trained to determine a valid value range for the new asset. The tokenization system applies the value range as a parameter for confirming transaction validity by the distributed network of nodes. In some cases, the tokenization system enables the real estate possessor to apply such data to better calibrate asset tokenization parameters. In some cases, the tokenization system enables a potential token owner to apply such data to evaluate different token purchase options.

Machine Learning Models to Optimize and/or Forecast Value of Tokens for Asset Owner and Token Owners while Leveraging Blockchain to Regulate Resource Allocation Governance

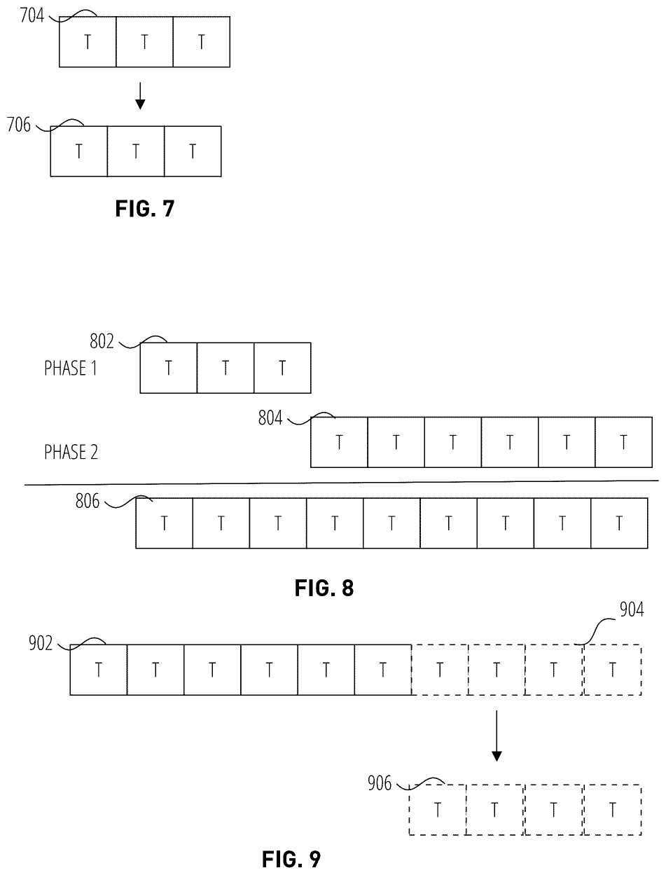

FIG. 7 to FIG. 11 illustrate examples of different modes for a decentralized protocol involving tokens for resource allocation, according to some examples. FIG. 7 illustrates a first mode for a conventional loan, according to some examples. In this mode, there is no collateral provided for the loan. The proposed asset 704 for the loan and the loan amount 706 are represented by 3 tokens (T T T). The loan amount 702 is equivalent to the value of the proposed asset 704.

The first mode represents a traditional loan scenario, but with the asset tokenized to provide additional benefits to lenders beyond simple interest repayment. The tokenization provides more flexibility, such as receiving returns on the tokens in the form of interest, benefits from market appreciation if the token values increase on the open market, and/or receiving a buyback guarantee from the asset owner to repurchase the tokens at a certain price at a later time.

FIG. 8 illustrates a second mode for another loan without collateral, according to some examples. The proposed asset is tokenized into a number of tokens (represented by T's). The tokenization system divides the asset plan into 2 phases and corresponding tokens 802 and 804. At each phase, the tokenization system enables transfer of the tokens from the property owner to recipients.

In some cases, the phases correspond to phases of development. Phases can include planning where market research, site analysis, financial analysis and/or conceptual design is performed. Another phase can include entitlement and approvals, where zoning and permits are obtained, the environment is studied and reviewed, community engagement is measured, design is developed, and/or the like.

In some cases, another phase includes preconstruction where architectural design, engineering, bidding, contractor selection, cost estimation, and/or the like is performed. In some cases, the next phase is construction including site preparation, foundation and infrastructure construction, mechanical, electrical, and plumbing installation, interior finishes, and/or the like.

In some cases, the following stage includes completing and handover including final inspections, quality assurance, handover to owners or tenants, and/or the like. In some cases, the final phase includes post-construction and operations including property management, marketing, leasing, agreements, asset management, and/or the like.

For example, in phase 1, the tokenization system enables transfer of 3 tokens during the first phase 802 to recipients, the first phase 802 being up to construction. Thus, new token recipients can buy/sell tokens during asset development (before it is completed) and/or within any phase.

The tokenization system can provide a risk tolerance, target appreciation expectation, and/or interest return expectation using a machine learning model based on training and data as further described herein. After acquiring tokens, the tokenization system provides returns and/or negates the need for interest payments based on dividends, such as a portion of the proceeds from the home being allocated to the token holder.

New token owners can hold tokens until the asset has been completed whereby the tokens can benefit from return on tokens (when asset is utilized) and/or based on market appreciation. In some cases, the tokenization system projects an expected change in market appreciation at least partially based on when they purchased (e.g., a machine learning model can factor in the earlier the purchase, the higher the expected change in value).

In some cases, the tokenization system provides a buyback guarantee from asset owner and/or the ability for tokens to be used toward of completed asset. For example, for the second phase 804, the recipients can transmit all tokens in the second phase 804, which is a phase when the property has been completed and tenants of the property are paying proceeds. As such, the recipients can over time gain all tokens 806 for full ownership of the property.

FIG. 9 illustrates a third mode regarding collateral for a loan, according to some examples. In some cases, the tokenization system enables a loan amount for a portion of the value. For example, the asset is valued as both the total number of tokens 902 and 904.

However, the tokenization system only provides a loan value of a certain percentage or amount based on the total value. For example, the tokenization system only provides loans for 40% of the total value (e.g., 10 tokens total, only 4 tokens 904 which is equivalent for a loan). The tokenization system provides the owner with a 4 token loan 906, enabling the property owner to gain the full benefit of the property's appreciation while having additional tokens to loan or sell on the open market to other recipients.

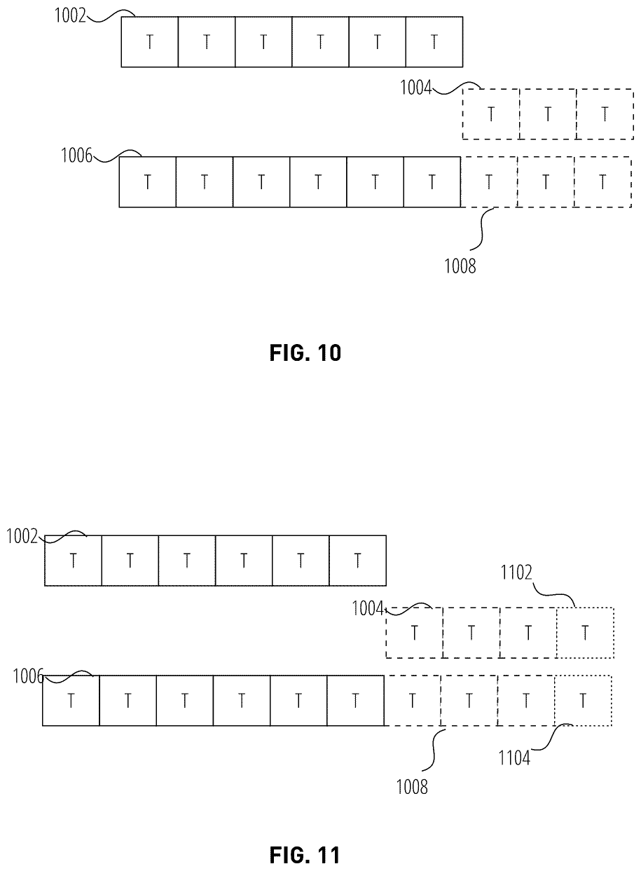

FIG. 10 illustrates a third mode illustrating token relocation based on appreciation in value of the property, according to some examples. In some cases, an existing asset has already been tokenized into 6 tokens 1002. The 6 tokens are sold into the market and purchase by recipients (recipient tokens 1006). As tokens are sold to recipients, these new token owners can benefit from return on such tokens, such as from market appreciation of token values or sudden changes in values. For example, the asset can appreciate or depreciate over time.

In some cases, the additional tokens generated over time 1004, such as through appreciation and/or through proceeds can be provided and distributed to the current token holders. As such, the total value of the home has appreciated over time to be valued as the combination of tokens 1006 and 1008.

FIG. 11 illustrates a fourth mode illustrating token relocation based on a sudden change in value of the property, according to some examples. In some cases, a modification or sudden damage occurs on the property. The tokenization system identifies such a sudden change in value and identifies that the change is equivalent to one token 1102. The tokenization system divides the one token 1102 and distributes to each token holder according to their fractional ownership. As such, the total value of the property is now the tokens 1006, the tokens 1008, and token 1104.

### Fungible Usage Rights for Real Estate Recipient and Users

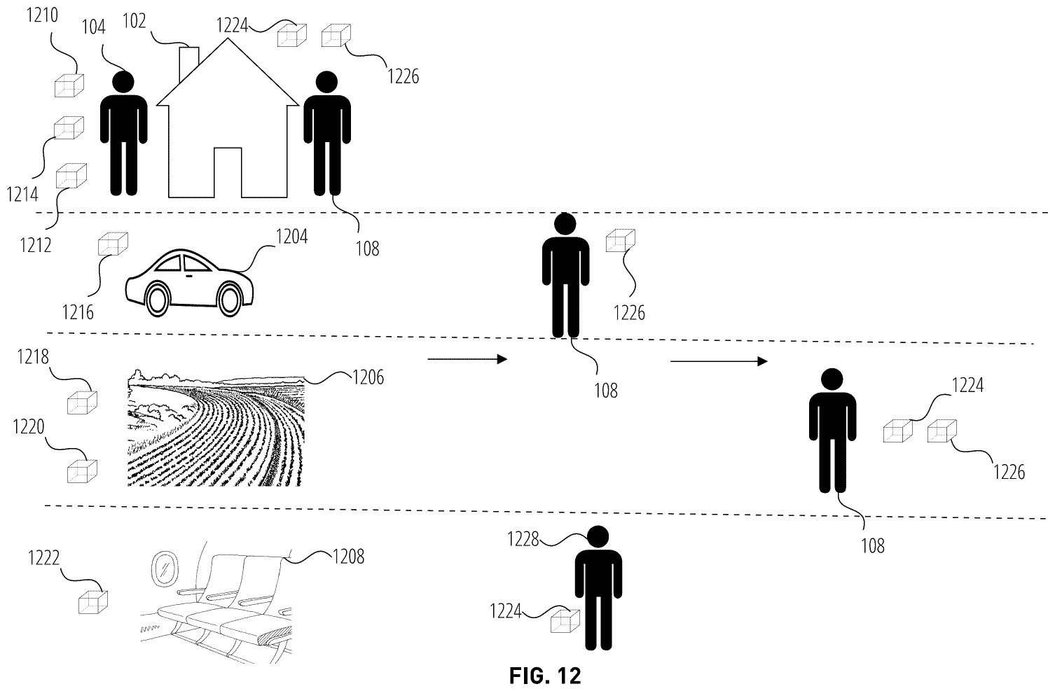

FIG. 12 illustrates fungible usage rights for the real estate recipient and users, according to some examples. The value for the usage of the home 102 is 3 tokens 1210, 1212, and 1214. In some cases, the value of the home itself is worth 3 tokens. The home owner 104 loans 2 tokens 1224 and 1226 to the user 108.

At a next time step, the user 108 decides to apply the two tokens to use the car 1204 (requiring 1 token 1216) and an airplane seat 1208 (requiring 1 token 1222). The user applies the tokens 1224 and 1226 to the tokenization system. The user applies token 1226 to use the car 1204 where the value for usage is one token 1216.

In some cases, the user can purchase or lease an asset to enable another party to use. For example, the user applies token 1224 for the airplane seat 1208. After acquiring usage rights for the airplane 1208, the user provides use of the airplane seat 1208 to another user 1228. The tokenization system distributes the proceeds received from the other user 1228 (such as for the purchase of the airplane seat) to the user 108 and the home owner who originally leased the token.

At a next time step, the user decides to use the farm land 1206 where the value for usage of the farm land is 2 tokens 1218 and 1220. The user 108 applies the two tokens to be able to use the farm land. In some cases, the user has usage rights to be able to loan the asset to another (such as the farm land to a farmer) to collect proceeds from the use of the asset. For example, the user can lease the land to a farmer and collect proceeds from the farmer (such as a rent amount and/or proceeds from the harvest). The tokenization system distributes the proceeds from the third party to the user and/or to the original owner of the asset, such as the original owner of the farm land. Likewise to the home, the tokenization system can record and release liens on these various assets and/or generate or modify property ownership certificates for such assets.

In some cases, the asset owner (such as the home owner) is obtaining a loan by temporarily selling tokens with the added guarantee of repurchase. The two tokens provided to the user are transmitted in response to a payment made by the user. The loan recipient (e.g., the user) and/or the asset owner can determine a specific buy-back price and/or a specific buy-back date.

As such, the tokenization system is far superior to competing secured loans or home equity loans in that the entire asset isn't at risk of loss in case of default. The loan provider is loaning tokens which can be a portion of the property and a portion of their returns, which can be later repurchased incrementally. It is also less risky for the lender since the token market is liquid and they can benefit from usage return sharing which is a fundamentally component of token ownership.

Moreover, the loan is broken into fragments of ownership. As such, loaning tokens allow for far easy repayments. Moreover, the repayments can be modified according to loan recipient requirements. For example, instead of one token for the entire desired loan amount the loan can be divided into 30 tokens where each token is repurchased monthly. In some cases, the repurchase back of the tokens include an interest over the amount paid for by the user to obtain the tokens initially.

In the case of repayment default by the original home owner, the loan recipient can obtain fractional ownership of the asset. For example, in response to the tokenization system not receiving a repayment amount for the leased tokens, the tokenization system generates or modifies an ownership document (such as a deed) to reflect fractional ownership between the home owner and loan recipient in the proportion indicative of the missed payment amount and/or the missed token relocation amount.

In some cases, a machine learning model can examine previous transactions stored on blockchain by the loan recipient (asset owner) to determine their credit worthiness. In some cases, the machine learning model uses this to generate loan terms, such as to correctly price their loan request, determine the loan size, token values, repurchase period, and/or the like.

A machine learning model can perform creditworthiness checking by analyzing various data points related to an individual's financial history, behavior, and other relevant information to determine the likelihood of them repaying a loan or credit. In some cases, the tokenization system uses the creditworthiness to determine other features as described herein (such as determining a token price, interest rate, repurchase date or price, and/or the like).

Relevant data is collected from various sources, including credit bureaus, financial institutions, and other data providers. This data includes information such as credit scores, credit reports, income, employment history, payment history, outstanding debts, past performance of previous token offers and/or repurchases stored on the blockchain, past performances of collateralized assets value changes over time, returns of assets, and/or the like.

The collected data is analyzed to identify relevant features or variables that can help assess an individual's creditworthiness. These features could include credit utilization ratio, number of open credit accounts, length of credit history, and recent credit inquiries.

Historical data on credit applicants, including whether they repaid their loans or defaulted, is used to create a labeled dataset. This dataset is divided into a training set and a validation set for training and evaluating the model. The machine learning model is trained on the labeled dataset to learn patterns and relationships between the input features and the loan repayment outcomes. The model's internal parameters are adjusted during training to minimize prediction errors.

Although the examples described herein describe an individual's creditworthiness, it is appreciated that the features described herein can apply to an asset's credit worthiness. For example, the relevant data can be applied for a particular asset and how individuals have used the asset for obtaining returns such as historical data on an apartment's occupancy rate, rent generation, cash flow, expenses, and/or the like. The tokenization system can apply the features of asset creditworthiness when generating the terms of the token loan for the asset.

The model's performance is evaluated using the validation dataset. Hyperparameters, which control the learning process, can be fine-tuned to optimize the model's performance. Once trained and validated, the model can make predictions on new credit applicants. The model evaluates the applicant's information and produces a prediction of their creditworthiness, usually in the form of a credit score or probability of default.

In some cases, a machine learning model performs loan underwriting that includes evaluating a borrower's creditworthiness and determining whether to approve or deny a loan application.

Relevant data about the borrower is collected, including personal information, credit history, income, employment status, loan amount, and purpose. This data forms the basis for assessing the borrower's creditworthiness. Machine learning models require relevant features or variables to make predictions. These features are extracted from the collected data, and they can include credit score, debt-to-income ratio, employment history, loan term, and more.

The model can predict the appropriate loan term and amount that align with the applicant's creditworthiness, income, and financial profile. For instance, it can suggest a shorter term for higher-risk applicants to mitigate risk. The model can predict an appropriate interest rate based on the applicant's creditworthiness and other relevant factors. Higher creditworthiness may lead to lower interest rates.

Since the loan is asset-backed, the model can consider collateral information to determine the loan-to-value ratio and assess the collateral's impact on loan terms. The model assesses the risk associated with the loan application by considering the applicant's creditworthiness, income stability, and other relevant features. The machine learning model can provide automated loan decisions by determining the loan parameters, interest rate, and other terms without manual intervention.

In asset-backed loans, collateral tracking is essential to ensure that the borrower maintains the value of the pledged asset throughout the loan term. By integrating Internet of Things (IoT) devices and/or using machine learning, lenders can perform real-time collateral tracking, enhancing transparency and risk management. In some cases, the tokenization system receives supply chain data to apply to processes, such as via machine learning models described herein. For example, the supply chain data is stored on the publicly accessible blockchain and the tokenization system uses such data to verify the quality of the asset and/or the subsequent expected performance of the tokens used to collateralize the loan. The tokenization system integrate this supply chain data with the tokenization system's blockchain by connecting different token sources from different assets so that the data from blockchains of previous tokens can be applied by the tokenization system and/or via the machine learning models described herein to forecast the performance of the tokens being used for collateral in a current time. As such, the entire loan process can be further self contained within the tokenization system.

IoT devices are deployed on the collateral asset. These devices can include sensors, GPS trackers, cameras, or any other relevant technology that can provide real-time data about the asset's condition, location, and usage.

IoT devices continuously collect and transmit data related to the asset. For instance, in a vehicle-backed loan, data might include information about the vehicle's location, mileage, engine status, fuel levels, and maintenance history.

The data collected by IoT devices is transmitted wirelessly to a centralized data platform. This tokenization platform processes and stores the incoming data for analysis.

Relevant features are extracted from the incoming data. These features could include factors such as distance traveled, engine health, usage patterns, and location history.

Historical data from IoT devices, along with corresponding collateral condition assessments, is used to create a labeled dataset. This dataset is divided into training and validation sets for training and evaluating the model. The machine learning model is trained using the labeled dataset. The model learns to identify patterns and relationships between the IoT data and the collateral's condition.

The trained model and/or other process of the tokenization system can predict the future condition of the collateral based on incoming IoT data. For example, it can predict when maintenance is required for a vehicle or when an asset's value might be compromised.

Machine learning models can identify anomalies in the IoT data, flagging instances where the asset's condition deviates significantly from the expected norm. This helps lenders take prompt action in case of potential collateral deterioration. If the model detects potential issues with the collateral's condition, it can trigger alerts or notifications to both the borrower and the lender, ensuring timely action.

Real-time data from IoT devices enables lenders to assess the risk associated with the asset-backed loan more accurately. It allows them to make informed decisions based on the asset's actual condition rather than relying solely on assumptions. Collateral tracking via IoT devices enhances transparency between borrowers and lenders, as both parties can access real-time information about the asset's condition.

Borrowers who effectively maintain their collateral's value may be rewarded with better loan terms or interest rates, leading to a more equitable lending environment. Machine learning-powered IoT-enabled collateral tracking not only improves risk management for lenders but also provides borrowers with a fair and transparent system for maintaining the value of their pledged assets.

Implementing blockchain technology to create self-executing smart contracts can revolutionize the way loan agreements, payments, and terms enforcement are handled. The tokenization system applies a machine learning model to determine contractual terms, and these terms are translated into code and stored on the blockchain as a smart contract. The contract includes details such as loan amount, interest rate, repayment schedule, and collateral.

The smart contract can be programmed to automatically execute based on predefined conditions. Once the borrower meets the specified criteria (e.g., creditworthiness assessment), the loan is approved without the need for manual intervention.

Upon approval, the smart contract can automatically release the loan amount to the borrower's account. This ensures that funds are disbursed accurately and efficiently. The smart contract includes a repayment schedule based on the terms agreed upon and/or a token repurchase date. Borrowers make payments according to the schedule, and the smart contract automatically updates the payment status.

Interest calculations can be automated within the smart contract based on the agreed-upon formula. This ensures accurate and consistent interest calculations over time. Borrowers' repayment installments are automatically deducted from their accounts and transferred to the lender's account according to the smart contract's instructions. The tokens are automatically transferred back to the lender.

If the loan is collateralized, the smart contract can monitor the collateral's value using external data feeds (e.g., market prices via oracles) or IoT devices (as further described herein) to assess the state of the collateral. In case of default, the smart contract can initiate collateral liquidation or transfer ownership to the lender. If a borrower defaults on payments, the smart contract can trigger predefined actions, such as penalty fees, altered repayment schedules, or collateral liquidation.

In some cases, the loan is not collateralized, such as in the case of tokenizing a new property under development. In such cases, new tokens for the property can be minted, and then the property can then be sold or held or used towards purchasing the property by the lender, as shown in FIGS. 10-11.

All transactions and changes to the smart contract are recorded on the blockchain, providing an immutable and transparent record of the loan agreement's execution. The smart contract enforces the terms of the loan agreement automatically, ensuring that both parties adhere to the agreed-upon conditions.

Smart contracts eliminate the need for intermediaries (e.g., lawyers, banks) and reduce administrative overhead, leading to faster and more cost-effective loan processes. Moreover, smart contracts are tamper-proof and secure. This reduces the risk of fraud and disputes, as all parties have access to the same, unchangeable record.

### Multi-User Multi-Asset-Slot Scenario for Loaning Tokens

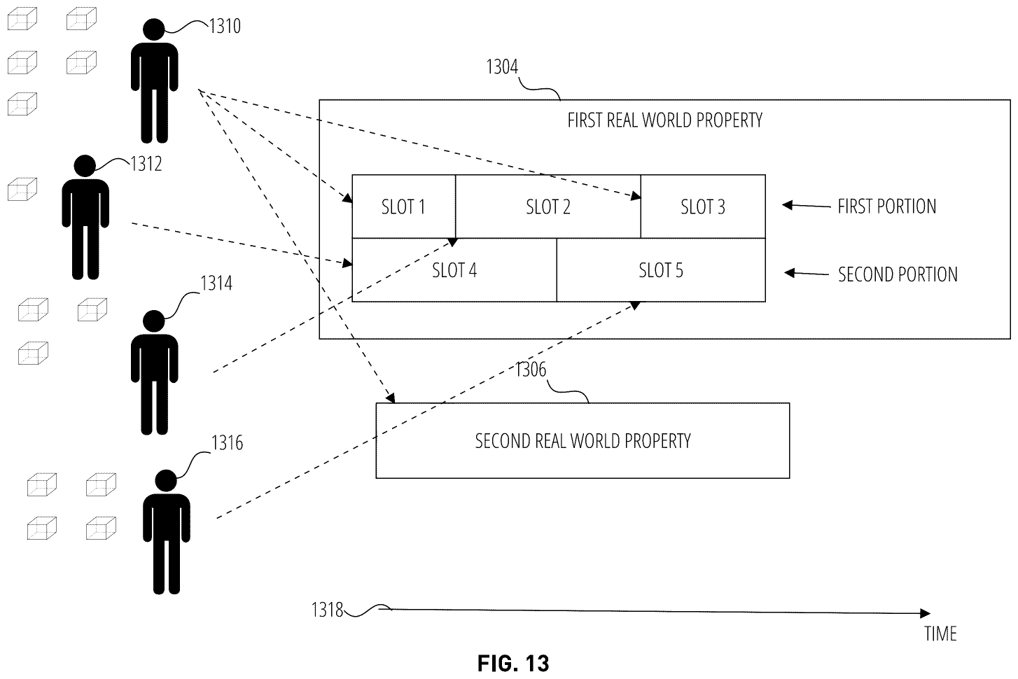

FIG. 13 illustrates an example of a multi-user multi-asset-slot scenario with tokenized real world assets for loaning tokens, according to some examples. There are multiple users, such as a first user 1310 with 5 tokens, a second user 1312 with 1 token, a third user 1314 with 3 tokens, and a fourth user 1316 with 4 tokens.

There are two real world properties, a first real world property 1304 and a second real world property 1306. The first real world property can be two different trucks in a fleet of trucks, represented by a first and second portion. The second real world property can be a transporter.

In some cases, the first user 1310, who has the most amount of tokens, can get first pick from the fleet by loaning the first user's 1310 tokens to the system or the owner of the real world properties. In some cases, the selection between users of real world properties occur as an auction, where the user with the highest bid gets access to usage rights of a certain property and/or a time period. In some cases, the tokenization system assigns users based on other characteristics, such as a first come first serve (first user to make a request), need based (e.g., affordable housing and/or factors considered for affordable housing), expected return from usage (e.g., sales from kiosks in tourist district), and/or the like.

In some cases, the first user 1310 gains access to the second real world property 1306 for the entire time period 1318 by loaning a certain amount of tokens to the second real world property user. The first user sets the repurchase date, interest payments, price buy back guarantee, and/or other terms of the use for the second user. The first user 1310 also gains access to the first truck in the first and third time slots by loaning the remaining amount of tokens to the first real world property owner. The second user 1312 gains access to the second truck at the fourth time slot, the third user 1314 gains access to the first truck at the second time slot, and the fourth user gains access to the second truck at the fifth time slot.

In some cases, the real world property usage rights are single time, single use (such as perishables), single time, multi use (such as identical rooms in a hotel), multi time, single use (such as a shared cooperative plane used for aerial seeding), multi time, multi use (such as seats on a scheduled train route), and/or the like.

### Machine Architecture

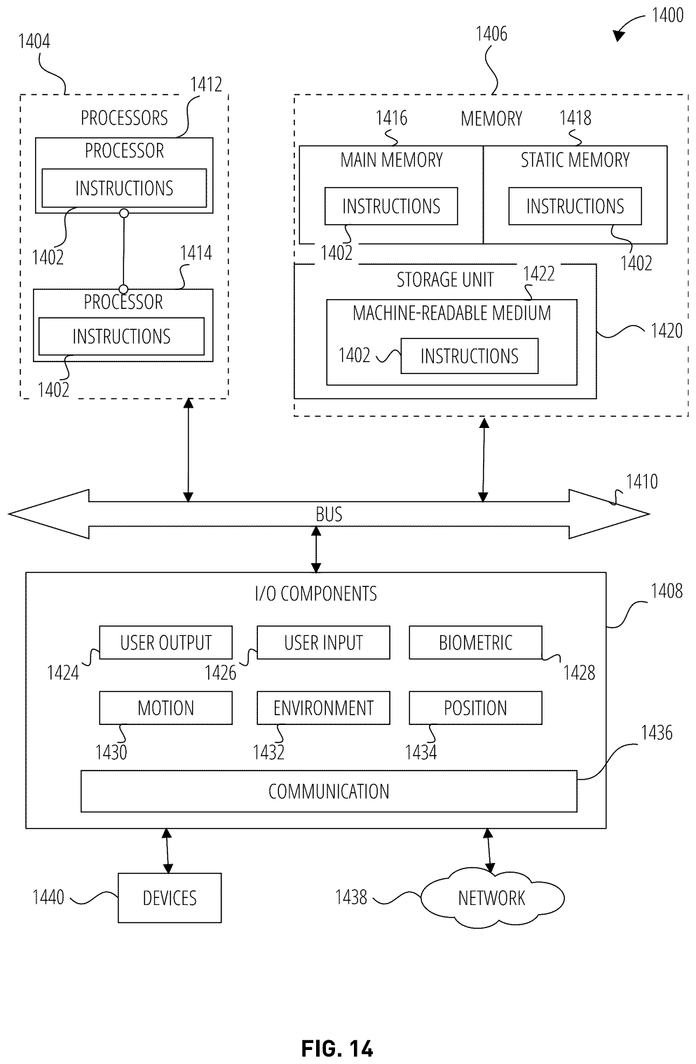

FIG. 14 is a diagrammatic representation of the machine 1400 within which instructions 1402 (e.g., software, a program, an application, an applet, an app, or other executable code) for causing the machine 1400 to perform any one or more of the methodologies discussed herein may be executed. For example, the instructions 1402 may cause the machine 1400 to execute any one or more of the methods described herein. The instructions 1402 transform the general, non-programmed machine 1400 into a particular machine 1400 programmed to carry out the described and illustrated functions in the manner described. The machine 1400 may operate as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1402, sequentially or otherwise, that specify actions to be taken by the machine 1400. Further, while a single machine 1400 is illustrated, the term “machine” shall also be taken to include a collection of machines that individually or jointly execute the instructions 1402 to perform any one or more of the methodologies discussed herein. The machine 1400, for example, may comprise a user system or any one of multiple server devices forming part of the server system. In some examples, the machine 1400 may also comprise both client and server systems, with certain operations of a particular method or algorithm being performed on the server-side and with certain operations of the particular method or algorithm being performed on the client-side.

The machine 1400 may include processors 1404, memory 1406, and input/output (I/O) components 808, which may be configured to communicate with each other via a bus 1410. In an example, the processors 1404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1412 and a processor 1414 that execute the instructions 1402. The term “processor” is intended to include multi-core processors that may comprise two or more independent processors (sometimes referred to as “cores”) that may execute instructions contemporaneously. Although FIG. 14 shows multiple processors 1404, the machine 1400 may include a single processor with a single-core, a single processor with multiple cores (e.g., a multi-core processor), multiple processors with a single core, multiple processors with multiples cores, or any combination thereof.

The memory 1406 includes a main memory 1416, a static memory 1418, and a storage unit 1420, both accessible to the processors 1404 via the bus 1410. The main memory 1406, the static memory 1418, and storage unit 1420 store the instructions 1402 embodying any one or more of the methodologies or functions described herein. The instructions 1402 may also reside, completely or partially, within the main memory 1416, within the static memory 1418, within machine-readable medium 1422 within the storage unit 1420, within at least one of the processors 1404 (e.g., within the processor's cache memory), or any suitable combination thereof, during execution thereof by the machine 1400.

The I/O components 1408 may include a wide variety of components to receive input, provide output, produce output, transmit information, exchange information, capture measurements, and so on. The specific I/O components 1408 that are included in a particular machine will depend on the type of machine. For example, portable machines such as mobile phones may include a touch input device or other such input mechanisms, while a headless server machine will likely not include such a touch input device. It will be appreciated that the I/O components 1408 may include many other components that are not shown in FIG. 14. In various examples, the I/O components 1408 may include user output components 1424 and user input components 1426. The user output components 1424 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1426 may include alphanumeric input components (e.g., a keyboard, a touch screen configured to receive alphanumeric input, video input (e.g., camera), peer-to-peer input (e.g., chatbot), a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1408 may include biometric components 1428, motion components 1430, environmental components 1432, or position components 1434, among a wide array of other components. The motion components 1430 include acceleration sensor components (e.g., accelerometer), gravitation sensor components, rotation sensor components (e.g., gyroscope).

The environmental components 1432 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gasses for safety or to measure pollutants in the atmosphere), or other components that may provide indications, measurements, or signals corresponding to a surrounding physical environment.

The position components 1434 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1408 further include communication components 1436 operable to couple the machine 1400 to a network 1438 or devices 1440 via respective coupling or connections. For example, the communication components 1436 may include a network interface component or another suitable device to interface with the network 1438. In further examples, the communication components 1436 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1440 may be another machine or any of a wide variety of peripheral devices (e.g., a peripheral device coupled via a USB).

Moreover, the communication components 1436 may detect identifiers or include components operable to detect identifiers. For example, the communication components 1436 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1436, such as location via Internet Protocol (IP) geolocation, location via Wi-Fi® signal triangulation, location via detecting an NFC beacon signal that may indicate a particular location, and so forth.

The various memories (e.g., main memory 1416, static memory 1418, and memory of the processors 1404) and storage unit 1420 may store one or more sets of instructions and data structures (e.g., software) embodying or used by any one or more of the methodologies or functions described herein. These instructions (e.g., the instructions 1402), when executed by processors 1404, cause various operations to implement the disclosed examples.

The instructions 1402 may be transmitted or received over the network 1438, using a transmission medium, via a network interface device (e.g., a network interface component included in the communication components 1436) and using any one of several well-known transfer protocols (e.g., hypertext transfer protocol (HTTP)). Similarly, the instructions 1402 may be transmitted or received using a transmission medium via a coupling (e.g., a peer-to-peer coupling) to the devices 1440.

### Software Architecture

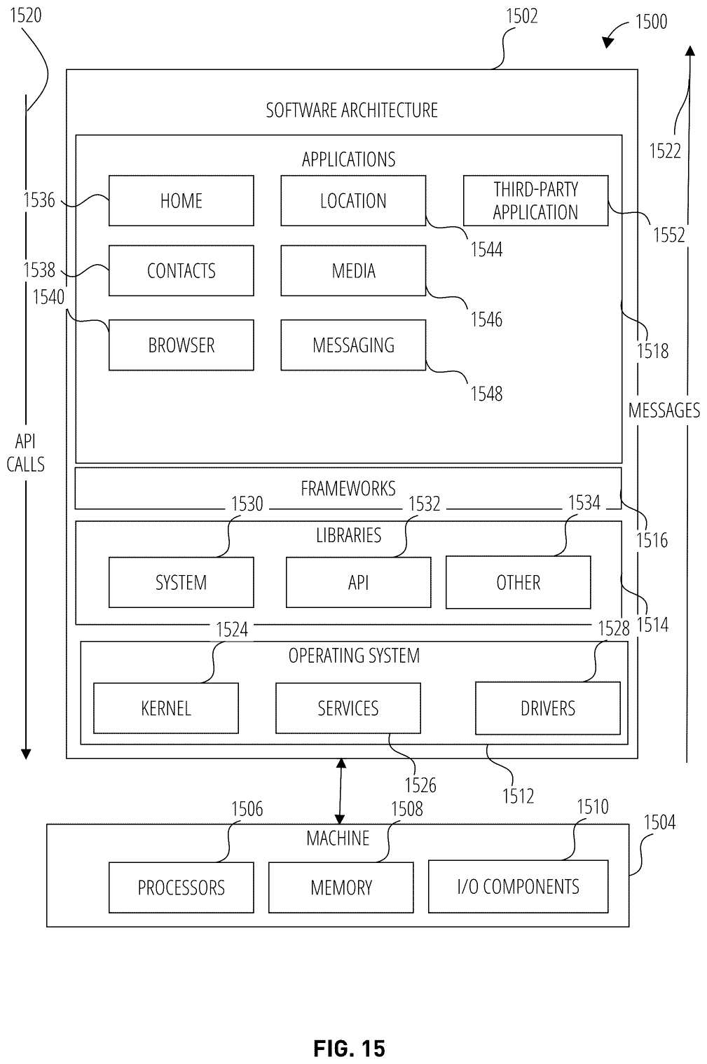

FIG. 15 is a block diagram 1500 illustrating a software architecture 1502, which can be installed on any one or more of the devices described herein. The software architecture 1502 is supported by hardware such as a machine 1504 that includes processors 1506, memory 1508, and I/O components 1510. In this example, the software architecture 1502 can be conceptualized as a stack of layers, where each layer provides a particular functionality. The software architecture 1502 includes layers such as an operating system 1512, libraries 1514, frameworks 1516, and applications 1518. Operationally, the applications 1518 invoke API calls 1520 through the software stack and receive messages 1522 in response to the API calls 1520.

The operating system 1512 manages hardware resources and provides common services. The operating system 1512 includes, for example, a kernel 1524, services 1526, and drivers 1528. The kernel 1524 acts as an abstraction layer between the hardware and the other software layers. For example, the kernel 1524 provides memory management, processor management (e.g., scheduling), component management, networking, and security settings, among other functionalities. The services 1526 can provide other common services for the other software layers. The drivers 1528 are responsible for controlling or interfacing with the underlying hardware. For instance, the drivers 1528 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1514 provide a common low-level infrastructure used by the applications 1518. The libraries 1514 can include system libraries 1530 (e.g., C standard library) that provide functions such as memory allocation functions, string manipulation functions, mathematic functions, and the like. In addition, the libraries 1514 can include API libraries 1532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1514 can also include a wide variety of other libraries 1534 to provide many other APIs to the applications 1518.

The frameworks 1516 provide a common high-level infrastructure that is used by the applications 1518. For example, the frameworks 1516 provide various graphical user interface (GUI) functions, high-level resource management, and high-level location services. The frameworks 1516 can provide a broad spectrum of other APIs that can be used by the applications 1518, some of which may be specific to a particular operating system or platform.

In an example, the applications 1518 may include a home application 1536, a contacts application 1538, a browser application 1540, a location application 1544, a media application 1546, a messaging application 1548, and a broad assortment of other applications such as a third-party application 1552. The applications 1518 are programs that execute functions defined in the programs. Various programming languages can be employed to create one or more of the applications 1518, structured in a variety of manners, such as object-oriented programming languages (e.g., Objective-C, Java, or C++) or procedural programming languages (e.g., C or assembly language). In a specific example, the third-party application 1552 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1552 can invoke the API calls 1520 provided by the operating system 1512 to facilitate functionalities described herein.

### Machine-Learning Pipeline

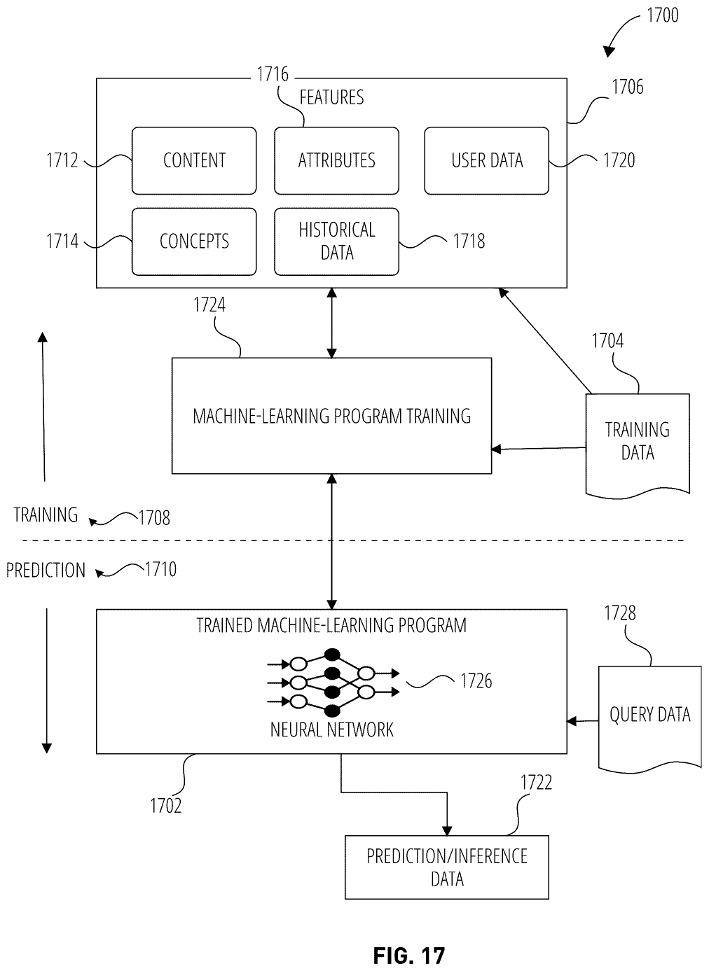

FIG. 17 is a flowchart depicting a machine-learning pipeline 1700, according to some examples. The machine-learning pipelines 1700 may be used to generate a trained model, for example the trained machine-learning program 1702 of FIG. 17, described herein to perform operations associated with searches and query responses.

### Overview

Broadly, machine learning may involve using computer algorithms to automatically learn patterns and relationships in data, potentially without the need for explicit programming to do so after the algorithm is trained. Examples of machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data. Evaluating the model on a separate test set helps to mitigate the risk of overfitting, a common issue in machine learning where a model learns to perform exceptionally well on the training data but fails to maintain that performance on data it hasn't encountered before. By using a test set, the system obtains a more reliable estimate of the model's real-world performance and its potential effectiveness when deployed in practical applications.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

### Phases

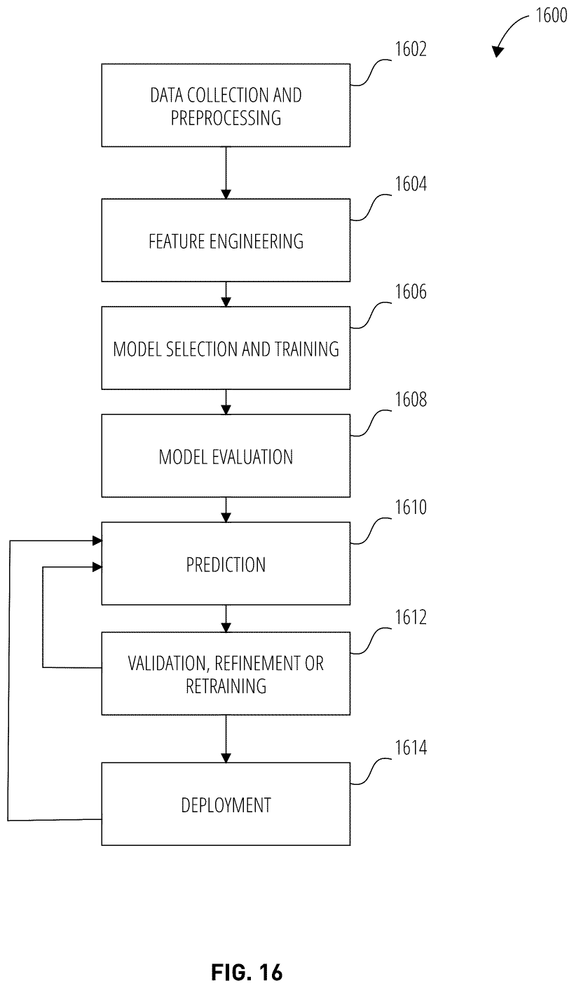

Generating a trained machine-learning program 1702 may include multiple types of phases that form part of the machine-learning pipeline 1700, including for example the following phases 1600 illustrated in FIG. 16:
Data collection and preprocessing 1602: This may include acquiring and cleaning data to ensure that it is suitable for use in the machine learning model. Data can be gathered from user content creation and labeled using a machine learning algorithm trained to label data. Data can be generated by applying a machine learning algorithm to identify or generate similar data. This may also include removing duplicates, handling missing values, and converting data into a suitable format.
Feature engineering 1604: This may include selecting and transforming the training data 1704 to create features that are useful for predicting the target variable. Feature engineering may include (1) receiving features 1706 (e.g., as structured or labeled data in supervised learning) and/or (2) identifying features 1706 (e.g., unstructured or unlabeled data for unsupervised learning) in training data 1704.
Model selection and training 1606: This may include specifying a particular problem or desired response from input data, selecting an appropriate machine learning algorithm, and training it on the preprocessed data. This may further involve splitting the data into training and testing sets, using cross-validation to evaluate the model, and tuning hyperparameters to improve performance. Model selection can be based on factors such as the type of data, problem complexity, computational resources, or desired performance.
Model evaluation 1608: This may include evaluating the performance of a trained model (e.g., the trained machine-learning program 1702) on a separate testing dataset. This can help determine if the model is overfitting or underfitting and if it is suitable for deployment.
Prediction 1610: This involves using a trained model (e.g., trained machine-learning program 1702) to generate predictions on new, unseen data.
Validation, refinement or retraining 1612: This may include updating a model based on feedback generated from the prediction phase, such as new data or user feedback.
Deployment 1614: This may include integrating the trained model (e.g., the trained machine-learning program 1702) into a larger system or application, such as a web service, mobile app, or IoT device. This can involve setting up APIs, building a user interface, and ensuring that the model is scalable and can handle large volumes of data.

FIG. 17 illustrates two example phases, namely a training phase 1708 (part of the model selection and trainings 1606) and a prediction phase 1710 (part of prediction 1610). Prior to the training phase 1708, feature engineering 1604 is used to identify features 1706. This may include identifying informative, discriminating, and independent features for the effective operation of the trained machine-learning program 1702 in pattern recognition, classification, and regression. In some examples, the training data 1704 includes labeled data, which is known data for pre-identified features 1706 and one or more outcomes.

Each of the features 1706 may be a variable or attribute, such as individual measurable property of a process, article, system, or phenomenon represented by a data set (e.g., the training data 1704). Features 1706 may also be of different types, such as numeric features, strings, vectors, matrices, encodings, and graphs, and may include one or more of content 1712, concepts 1714, attributes 1716, historical data 1718 and/or user data 1720, merely for example. Concept features can include abstract relationships or patterns in data, such as determining a topic of a document or discussion in a chat window between users. Content features include determining a context based on input information, such as determining a context of a user based on user interactions or surrounding environmental factors. Context features can include text features, such as frequency or preference of words or phrases, image features, such as pixels, textures, or pattern recognition, audio classification, such as spectrograms, and/or the like. Attribute features include intrinsic attributes (directly observable) or extrinsic features (derived), such as identifying square footage, location, or age of a real estate property identified in a camera feed. User data features include data pertaining to a particular individual or to a group of individuals, such as in a geographical location or that share demographic characteristics. User data can include demographic data (such as age, gender, location, or occupation), user behavior (such as browsing history, purchase history, conversion rates, click-through rates, or engagement metrics), or user preferences (such as preferences to certain video, text, or digital content items). Historical data includes past events or trends that can help identify patterns or relationships over time.

In training phases 1708, the machine-learning pipeline 1700 uses the training data 1704 to find correlations among the features 1706 that affect a predicted outcome or prediction/inference data 1722.

With the training data 1704 and the identified features 1706, the trained machine-learning program 1702 is trained during the training phase 1708 during machine-learning program training 1724. The machine-learning program training 1724 appraises values of the features 1706 as they correlate to the training data 1704. The result of the training is the trained machine-learning program 1702 (e.g., a trained or learned model).

Further, the training phase 1708 may involve machine learning, in which the training data 1704 is structured (e.g., labeled during preprocessing operations), and the trained machine-learning program 1702 implements a relatively simple neural network 1726 capable of performing, for example, classification and clustering operations. In other examples, the training phase 1708 may involve deep learning, in which the training data 1704 is unstructured, and the trained machine-learning program 1702 implements a deep neural network 1726 that is able to perform both feature extraction and classification/clustering operations.

A neural network 1726 may, in some examples, be generated during the training phase 1708, and implemented within the trained machine-learning program 1702. The neural network 1726 includes a hierarchical (e.g., layered) organization of neurons, with each layer including multiple neurons or nodes. Neurons in the input layer receive the input data, while neurons in the output layer produce the final output of the network. Between the input and output layers, there may be one or more hidden layers, each including multiple neurons.

Each neuron in the neural network 1726 operationally computes a small function, such as an activation function that takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, which can affect their performance on different tasks. Overall, the layered organization of neurons and the use of activation functions and weights enable neural networks to model complex relationships between inputs and outputs, and to generalize to new inputs that were not seen during training.

In some examples, the neural network 1726 may also be one of a number of different types of neural networks or a combination thereof, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1708, a validation phase may be performed evaluated on a separate dataset known as the validation dataset. The validation dataset is used to tune the hyperparameters of a model, such as the learning rate and the regularization parameter. The hyperparameters are adjusted to improve the performance of the model on the validation dataset.

The neural network 1726 is iteratively trained by adjusting model parameters to minimize a specific loss function or maximize a certain objective. The system can continue to train the neural network 1726 by adjusting parameters based on the output of the validation, refinement, or retraining block 1612, and rerun the prediction 1610 on new or already run training data. The system can employ optimization techniques for these adjustments such as gradient descent algorithms, momentum algorithms, Nesterov Accelerated Gradient (NAG) algorithm, and/or the like. The system can continue to iteratively train the neural network 1726 even after deployment 1614 of the neural network 1726. The neural network 1726 can be continuously trained as new data emerges, such as based on user creation or system-generated training data.

Once a model is fully trained and validated, in a testing phase, the model may be tested on a new dataset that the model has not seen before. The testing dataset is used to evaluate the performance of the model and to ensure that the model has not overfit the training data.

In prediction phase 1710, the trained machine-learning program 1702 uses the features 1706 for analyzing query data 1728 to generate inferences, outcomes, or predictions, as examples of a prediction/inference data 1722. For example, during prediction phase 1710, the trained machine-learning program 1702 is used to generate an output. Query data 1728 is provided as an input to the trained machine-learning program 1702, and the trained machine-learning program 1702 generates the prediction/inference data 1722 as output, responsive to receipt of the query data 1728. Query data can include a prompt, such as a user entering a textual question or speaking a question audibly. In some cases, the system generates the query based on an interaction function occurring in the system, such as a user interacting with a virtual object, a user sending another user a question in a chat window, or an object detected in a camera feed.

In some examples the trained machine-learning program 1702 may be a generative AI model. Generative AI is a term that may refer to any type of artificial intelligence that can create new content from training data 1704. For example, generative AI can produce text, images, video, audio, code or synthetic data that are similar to the original data but not identical.

Some of the techniques that may be used in generative AI are:
Convolutional Neural Networks (CNNs): CNNs are commonly used for image recognition and computer vision tasks. They are designed to extract features from images by using filters or kernels that scan the input image and highlight important patterns. CNNs may be used in applications such as object detection, facial recognition, and autonomous driving.
Recurrent Neural Networks (RNNs): RNNs are designed for processing sequential data, such as speech, text, and time series data. They have feedback loops that allow them to capture temporal dependencies and remember past inputs. RNNs may be used in applications such as speech recognition, machine translation, and sentiment analysis
Generative adversarial networks (GANs): These are models that consist of two neural networks: a generator and a discriminator. The generator tries to create realistic content that can fool the discriminator, while the discriminator tries to distinguish between real and fake content. The two networks compete with each other and improve over time. GANs may be used in applications such as image synthesis, video prediction, and style transfer.
Variational autoencoders (VAEs): These are models that encode input data into a latent space (a compressed representation) and then decode it back into output data. The latent space can be manipulated to generate new variations of the output data. They may use self-attention mechanisms to process input data, allowing them to handle long sequences of text and capture complex dependencies.
Transformer models: These are models that use attention mechanisms to learn the relationships between different parts of input data (such as words or pixels) and generate output data based on these relationships. Transformer models can handle sequential data such as text or speech as well as non-sequential data such as images or code.

In generative AI examples, the prediction/inference data 1722 that is output include trend assessment and predictions, translations, summaries, image or video recognition and categorization, natural language processing, face recognition, user sentiment assessments, advertisement targeting and optimization, voice recognition, or media content generation, recommendation, and personalization.

Usage Cases for Tokenization, Ownership, Use, and/or the Like

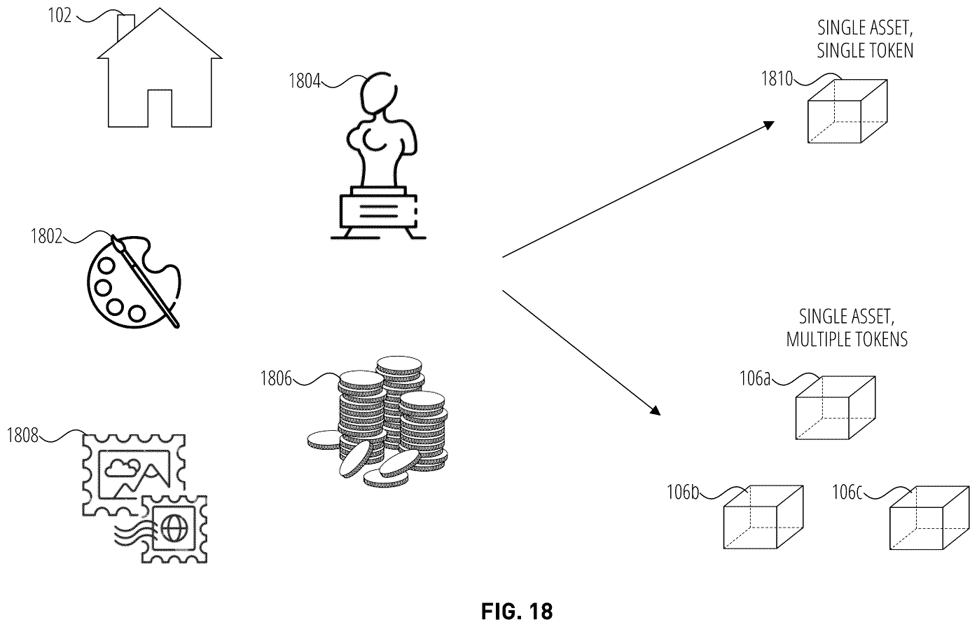

FIG. 18 illustrates tokenization of an asset as a whole, according to some examples. In some cases, a real world asset is not divided into parts by the tokenization system. For example, a home 102 is tokenized as a whole and not divided into different rooms. In some cases, the tokenization system tokenizes assets that are not easily dividable without changing the asset itself, such as a sculpture 1804, a painting 1802, a stamp in a stamp collection 1808, a coin in a rare coin collection 1806, and/or the like.

In some cases, the tokenization system generates and/or mints a single token 1810 corresponding to ownership or usage rights for the individual asset. In other cases, the tokenization system generates and/or mints multiple tokens 106a, 106b, 106c representing fractional ownership and/or different usage rights for the individual asset.

As users gain ownership and/or usage rights for the individual asset, users can start utilizing the asset as per the agreement and/or contractual terms (as further described herein).

In some cases, asset owners can jointly tokenize assets. For example, the artist and sculptor can jointly tokenize their paintings and sculptures. The joint assets can be tokenized either into a single token or multiple tokens. In some cases, the individual assets are valuated and tokens are assigned respectively. In other cases, a single token provides ownership and/or usage of the joint assets.

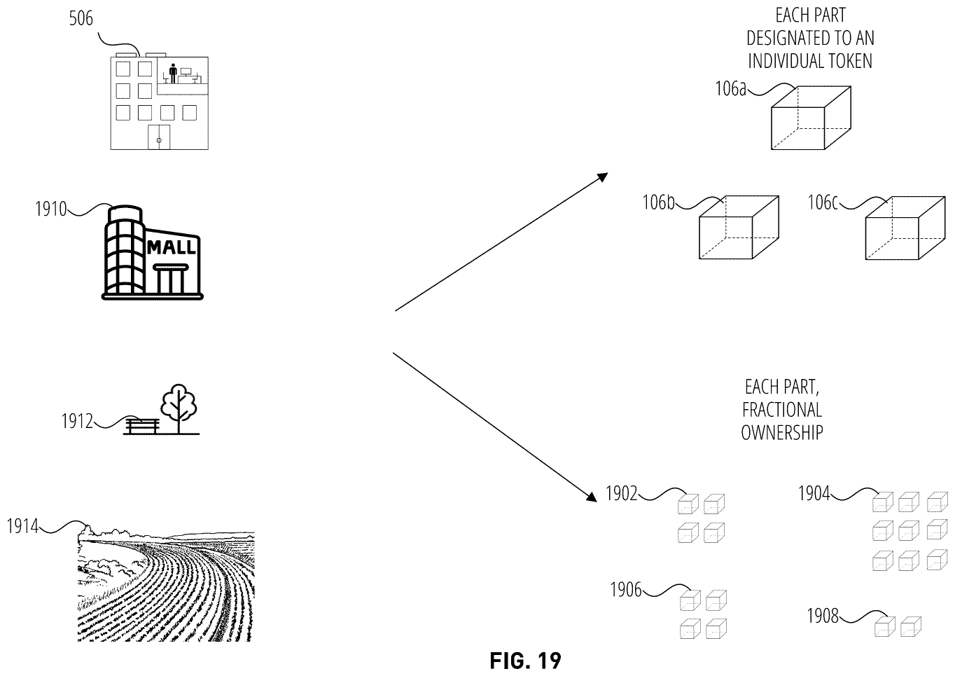

FIG. 19 illustrates tokenization of an asset that is divisible into parts, according to some examples. The tokenization system can divide an asset, such as a building 506, a mall 1910, a park 1912, farm land 1914, into parts and tokenize individual parts for use and/or ownership. For example, a building can be divided into apartments, a mall can be divided into sections for stores, farm land divided into parcels, and/or the like.

In some cases, the tokenization system generates an individual usage and/or ownership token for each divisible part, such as token 106a for a first apartment unit, token 106b for a second apartment unit, and 106c for a third apartment unit. In other cases, the tokenization system generates multiple tokens for each part, such as tokens 1902 for a first store front, tokens 1904 for a second store front, tokens 1906 for a third store front, tokens 1908 for a fourth store front and/or the like. In some cases, the amount of tokens for each part is determined using the valuation methods and processes as further described herein.

In some cases, the tokenization system identifies divisible parts based on third party data, such as data on the number of units in an apartment building retrieved from a real estate or government website. In some cases, the tokenization system applies a machine learning model that is trained to automatically determine divisible portions of a particular asset. For example, the machine learning model can receive as input an address of an asset, a type of asset (such as if the asset type indicates a divisible number of parts such as a duplex), input from the asset owner of characteristics of the asset, and/or the like (other inputs to the machine learning model further described herein).

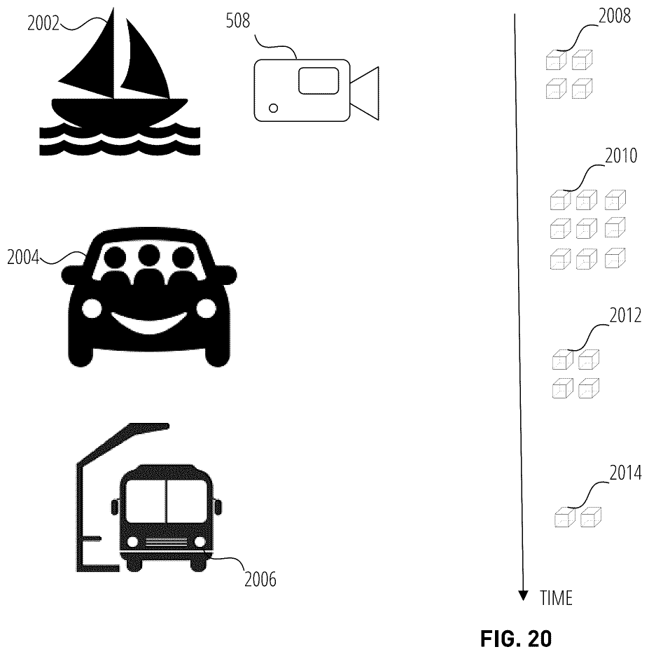

FIG. 20 illustrates tokenizing ownership and/or usage across time, according to some examples. In some cases, the tokenization system can tokenize an asset, such as a boat 2002, equipment 508, car 2004, public transportation 2006, and/or the like over time. The tokenization system applies ownership and/or usage rights over time. For example, a boat 2002 can be rented throughout the year for the use in boat tours.

The tokenization system can generate tokens according to the time and/or time frame desired for ownership and/or usage. For example, the tokenization system determines that boat tours are in demand in certain parts of the year but not in others. The tokenization system can apply the valuation methods and processes as further described herein to value the ownership and/or usage for particular time periods. For example, the time frame for tokens 2010 are in high demand, and thus more tokens are required for ownership and/or usage for these time slots, whereas the time periods for tokens 2008, 2012, and 2014 are in less demand and thus less tokens are minted for these time periods.

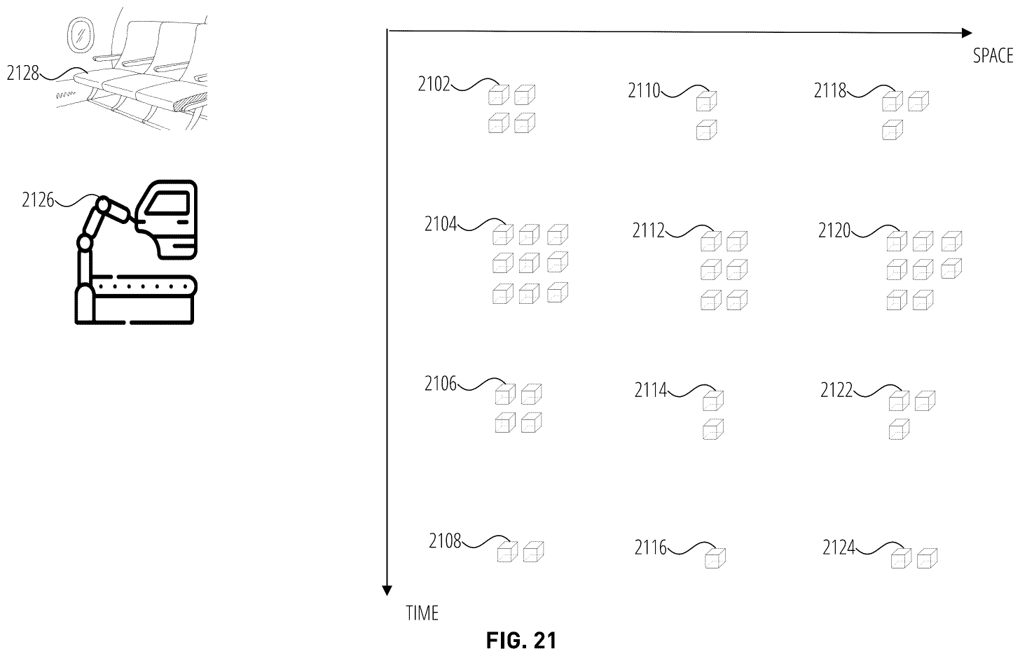

FIG. 21 illustrate tokenizing ownership and/or usage across time and parts, according to some examples. In some cases, the tokenization system tokenizes an asset across time and space. For example, the tokenization system divides an airplane 2128 into multiple seats or a multiple factory production lines in a factory 2126.

An airplane can have tens or hundreds of seats, each of which could be tokenized. In some cases, a group of seats can be tokenized, such as 4 seats for a family of 4. Such tokens can be tied to a particular airplane or to an airline with a fleet of airplanes.

In some cases, the tokenization system tokenizes ownership and/or usage across multiple factors, such as time and parts. It is appreciated that the tokenization system can tokenize an asset across one or more other factors, such as time and location, time parts and location, and/or the like.

As noted herein, the tokenization system can determine a valuation for the token based on these factors. In FIG. 21, the tokenization system determines that the certain seats at a particular time frame corresponding to tokens 2104 and 2120 are the highest in demand or highest in cost. As such, the more tokens are minted for the seats and time corresponding to tokens 2104 and 2120 than that for tokens 2102, 2110, 2118, 2112, 2106, 2114, 2122, 2108, 2116, and 2124.

In some cases, a factory with multiple production lines can tokenize each production line over different periods of time. Ownership of Tokens allow for the usage of associated production lines and collection of proceeds from the product line output. In some cases, a livestock production facility can tokenize each production line and across multiple cycles within a calendar year and offer those tokens to individual operators. These operators can make use of the facility for their own production and/or further offer the production line to other operators who could make use of the facility.

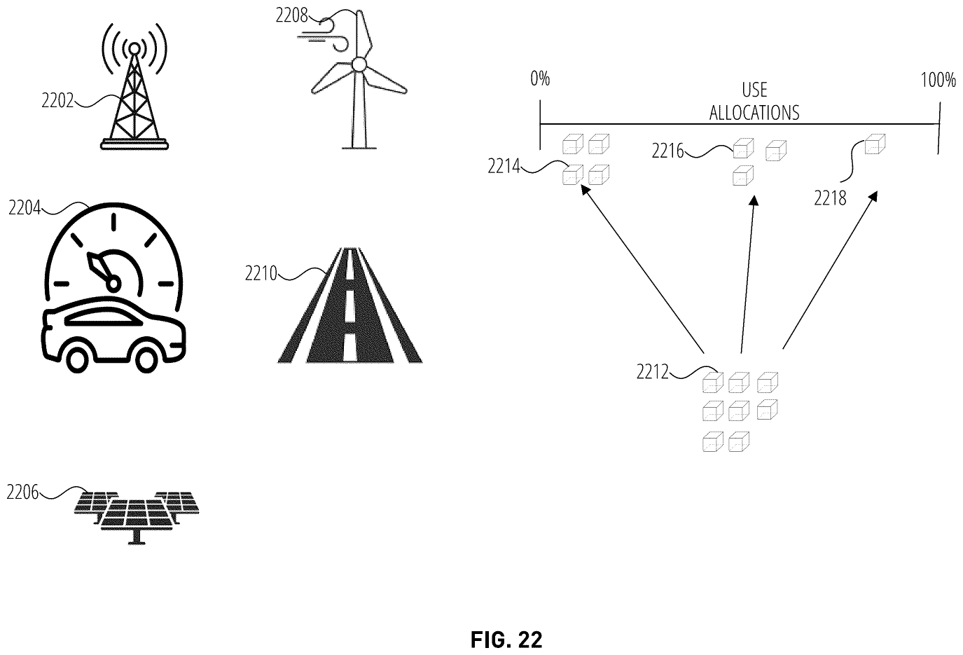

FIG. 22 illustrates tokenization for use allocations, according to some examples. The tokenization system can tokenize use allocations for assets. The tokenization system can tokenize cellphone towers 2202 such as based on data bandwidth usage. The tokenization system can tokenize amount of electricity generation by a wind turbine 2208 or solar farms 2206. The tokenization system can tokenize automobiles 2204 based on mileage. The tokenization system can tokenize use of roads 2210, such as an amount of traffic or length of travel.

Use allocations can be uniform across use, such as allocating the same amount of tokens for use of an automobile from 0-10 miles, 10-20 miles, 20-30 miles, etc. As shown in FIG. 22, use allocations can be different across use allocations. The automobile can be equivalent to a total token group 2212. However the use of the automobile may be of a higher value when the automobile is new. As such, the first group of miles for the automobile may be worth more tokens, such as tokens 2214, than when the automobile is at the middle of its lifespan, such as tokens 2216, or the end of its lifespan, such as token 2218.

In some cases, the tokenization system tokenizes cellphone towers (e.g., data use), automobile or farm equipment (e.g., mileage), oil wells, solar farms, wind turbines, other energy sources, mining rights, water rights, fishing quotas, bridges, toll roads, public transport, locations with services (e.g., fitness center, copy center, restaurant), and/or the like.

The tokenization system can tokenize an internet provider based on a provided bandwidth. The tokenization system can generate tokens representative of portions of bandwidth usage and provide such tokens to a large user base or virtual providers. The owners of these tokens can then use the associated bandwidth or sell the bandwidth to other users. A geographically diverse shared electricity grid can also tokenize its production of electricity and offer tokens to individual electricity producers that best meet the demands of their customers. Both these examples demonstrate the ability of the tokenization system to improve utilization of temporal assets that would be lost if not used immediately.

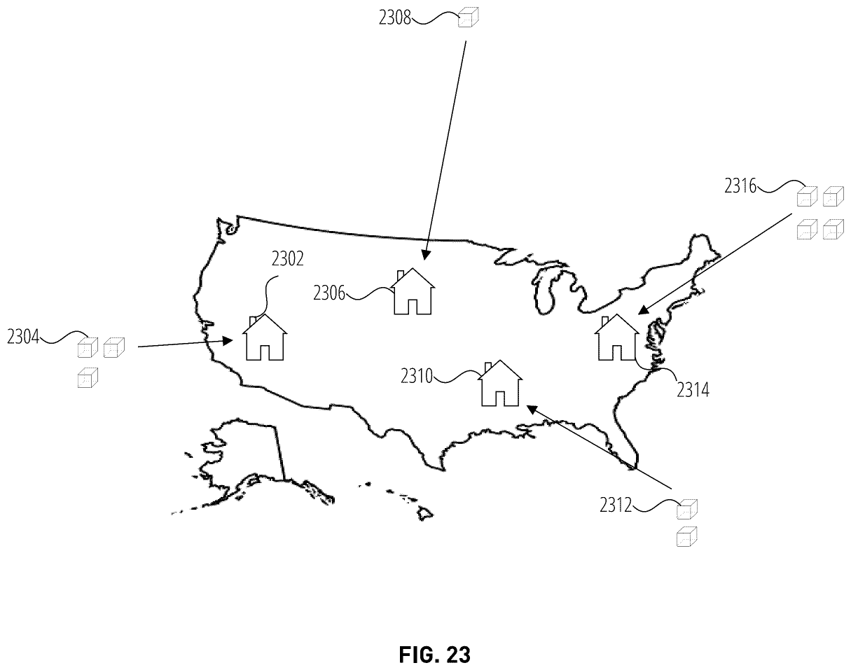

FIG. 23 illustrates token generation based on location, according to some examples. In some cases, the tokenization system tokenizes homes 2302, 2306, 2310, and 2314. Depending on the location of the home, the home may be valued differently. The tokenization system takes into consideration location, and/or other characteristics as described further herein in the valuation model, to determine a number of tokens to generate for the home. For example, home 2302 is provided with 3 tokens 2304, home 2306 is provided with 1 token 2308, home 2310 is provided with 2 tokens 2312, and home 2314 is provided with 4 tokens 2316.

In some cases, the tokenization system tokenizes medical facilities, clinics, wellness centers, companies (legal practices, accounting firms, consulting firms, research centers, etc.), and/or the like based on at least location.

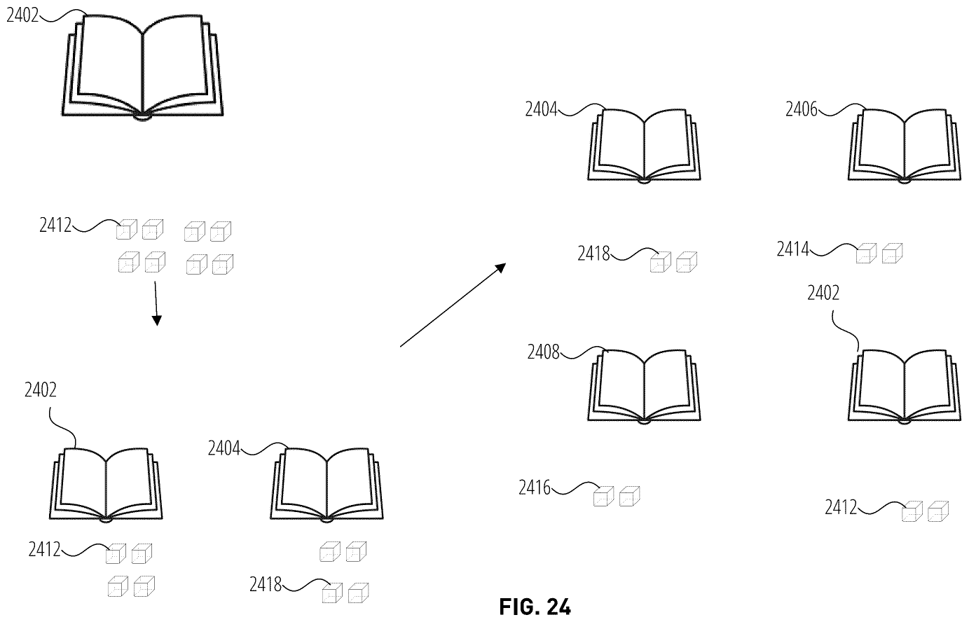

FIG. 24 illustrates token generation for copies of goods, according to some examples. In some cases, the tokenization system tokenizes copies of goods, such as artwork, creative works, books, movies, designs, architectural plans, educational content, music, software, formulas, recipes, advertisements, intellectual property, machine learning models, virtual objects (objects in virtual reality, augmented reality, mixed reality, etc), in-game items, in-application items, pharmaceuticals, and/or the like.

In some cases, as more copies are made, the more tokens are generated and/or the reduction of value for each token. For example, a book 2402 without any copies can be equivalent to 8 tokens 2412. The tokenization system can generate a first copy 2404 of the book and with the generated first copy, divide the number of tokens (e.g., 2412, 2414) equally between the original book 2402 and the first copy 2404. As such, the owner can decide how many copies to generate and how granular the owner desires the tokens and asset to be sold. In the next step, second copy 2406 and third copy 2408 are generated, and the tokenization system generates tokens 2418 and 2416 respectively. As shown in FIG. 24, after there are 4 copies in existence, the value for each book is reduced from 8 tokens down to 2 tokens each.

Although particular examples are described herein, such as a home being non-divisible and tokenized, it is appreciated that the example assets described herein can be applied to other types of tokenization. For example, the home 102 can be tokenized for usage across time, such as a short term rental.

The previous use cases can be combined whereby different features can be obtained from each case. This allows for a large amount of flexibility according to the underlying assets and intended usage. For example, the tokenization system can use the same tokens for different assets enabling flexibility in exchange of assets. For example, the tokenization system can apply tokens from a token owner issued by the same asset owner for use of different assets even if the assets are different or have different usage models.

Assets can be owned by a single or multiple asset owners. An asset owner can have a single or multiple assets. Assets can be used by a single or multiple tenants simultaneously. Asset usage can span a single or multiple time periods. A tenant may be allowed to utilize the asset for themselves only or offer it to be utilized by others. Intermediaries can borrow Tokens and acquire some asset ownership rights to offer the assets to other tenants. Asset utilization returns are shared with all token owners and potentially a portion of tenant returns. The asset itself can be made eligible for ownership if enough tokens are owned by a tenant.

As further described herein, the ownership and/or usage can be on a first come first serve basis, the tokenization system can implement a bidding auction whereby users can bid tokens and/or payments for a certain ownership or usage of an asset, and/or the like.

### Examples

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and at least one memory component storing instructions that, when executed by the at least one processor, cause the at least one processor to perform operations comprising: receiving a first real estate possession record for a first real estate from a first real estate possessor; identifying a value of the first real estate; generating a plurality of digital tokens by a group of nodes of a blockchain, a number of the generated plurality of digital tokens based on the value of the first real estate based on the value and a value for each digital token, each digital token representing a fractional ownership interest in the first real estate; transmitting the generated digital tokens to a digital token storage associated with the first real estate possessor; recording a lien on the first real estate possession record and a record of the digital tokens transmitted to the digital token storage associated with the first real estate possessor onto a distributed ledger of the blockchain; initiate a first digital token relocation for a real estate recipient, the first digital token relocation transmitting a first subset of digital tokens from the digital token storage associated with the first real estate possessor to a digital token storage associated with the real estate recipient and recording the transmission of the first subset onto the distributed ledger; periodically, during a first real estate utilization period for a real estate user: receiving an indication of a second digital token relocation from the real estate user utilizing the first real estate; transmitting a first portion of the second digital token relocation transmitted to the digital token storage associated with the first real estate possessor; transmitting a second portion of the second digital token relocation to the digital token storage associated with the real estate recipient, the first and second portions being based on digital tokens stored in digital token storage of the first real estate possessor and the real estate recipient; and recording a record of the first and second portions being transmitted onto the distributed ledger of the blockchain.

In Example 2, the subject matter of Example 1 includes, wherein the operations further comprise receiving an indication of a third digital token relocation, wherein in response to receiving the indication of the third digital token relocation: transmitting the first subset of digital tokens from the digital token storage associated with the first real estate recipient to the digital token storage associated with the real estate possessor.

In Example 3, the subject matter of Example 2 includes, wherein further in response to receiving the indication of the third digital token relocation: transmitting digital tokens stored in the digital token storage associated with the real estate user to the digital token storage associated with the real estate possessor and removing the lien on the first real estate possession record.

In Example 4, the subject matter of Example 3 includes, wherein removing the lien comprises recording a modified first real estate possession record that removes the lien or generating a new first real estate possession record without the lien.

In Example 5, the subject matter of Examples 1-4 includes, wherein the operations further comprise applying a machine learning model to receive an expected return for digital token relocations submitted by real estate recipients over a period of time.

In Example 6, the subject matter of Examples 1-5 includes, wherein the operations further comprise receiving a restriction on digital token relocations for real estate recipients, wherein the restriction comprises a time period for submitting digital token relocations by real estate recipients or a required value for the digital token relocations submitted by real estate recipients.

In Example 7, the subject matter of Examples 1-6 includes, wherein the second digital token relocation includes the real estate user submitting the second digital token relocation using digital tokens stored in the digital token storage of the real estate user.

In Example 8, the subject matter of Examples 1-7 includes, wherein the operations further comprise: determining whether a quantity of digital tokens within the digital token storage of the real estate user meets the number of digital tokens corresponding to the value of the first real estate; and causing recordation of a change to the first real estate possession record for the first real estate.

In Example 9, the subject matter of Example 8 includes, wherein the operations further comprise determining that the quantity of digital tokens within the digital token storage of the real estate user is meets or is greater than the number of digital tokens corresponding to the value of the first real estate, and causing recordation of the change comprises causing recordation of the first real estate possession record for the first real estate to the real estate user.

In Example 10, the subject matter of Examples 8-9 includes, wherein the operations further comprise determining that the quantity of digital tokens within the digital token storage of the real estate user is less than the number of digital tokens corresponding to the value of the first real estate, and causing recordation of the change comprises causing recordation of the first real estate possession record for the first real estate to the first real estate possessor.

In Example 11, the subject matter of Examples 8-10 includes, wherein the operations further comprise: periodically, during a second real estate utilization period for a second real estate for the real estate user: receiving an indication of a third digital token relocation from the real estate user utilizing the second real estate; and transferring a number of digital tokens corresponding to at least a portion of the third digital token relocation from the digital token storage of a second real estate possessor to a digital token storage of the real estate user; determining that a quantity of digital tokens within the digital token storage of the real estate user meets or exceeds than the number of digital tokens corresponding to the value of the second real estate; and recording a second real estate possession record from the second real estate possessor for the second real estate to the real estate user.

In Example 12, the subject matter of Example 11 includes, wherein the operations further comprise: in response to recording the second real estate possession record for the second real estate to the real estate user, purging the digital tokens corresponding from a circulating supply of digital tokens.

In Example 13, the subject matter of Examples 11-12 includes, wherein the quantity of digital tokens within the digital token storage of the real estate user when determining that the quantity of digital tokens within the digital token storage of the real estate user meets or exceeds than the number of digital tokens corresponding to the value of the second real estate comprises digital tokens acquired during use of the second real estate and digital tokens acquired during use of the second real estate.

In Example 14, the subject matter of Examples 1-13 includes, wherein the operations further comprise: in response to a lapse of the first real estate utilization period for the real estate user, determine whether a quantity of digital tokens within the digital token storage of the real estate user equals or exceeds the number of digital tokens corresponding to the value of the first real estate; and in response to determining that the quantity of digital tokens within the digital token storage of the real estate user does not equal or exceed the number of digital tokens corresponding to the value of the first real estate, renew the first real estate utilization period.

In Example 15, the subject matter of Examples 1-14 includes, wherein the first real estate includes a real estate property, the first real estate possession record including a digitized deed, and the first real estate possessor including a real estate property owner, wherein the first real estate utilization period is for a lease agreement, the real estate user including a tenant.

In Example 16, the subject matter of Examples 1-15 includes, wherein the operations further comprise: performing optical character recognition (OCR) on the first real estate possession record, and converting data identified from performing the OCR into a standardized format, identifying the value of the first real estate being based on the converted data.

In Example 17, the subject matter of Examples 1-16 includes, wherein the operations further comprise: providing the real estate user with access to the first real estate by at least one of: generating a unique access code for a digital lock or security system of the first real estate, transmitting a signal to one or more Internet of Things (IoT) devices associated with the first real estate such that the one or more IoT devices grants access to the real estate user, or automatically booking the first real estate for the real estate user for the first real estate utilization period.

In Example 18, the subject matter of Examples 1-17 includes, wherein the first real estate includes a collection of physical properties, wherein the real estate user is able to use one of the physical properties, wherein the tokens represent fractional ownership for the collection of the physical properties, wherein the value of the tokens required for the transfer of ownership is the value of the collection of the physical properties.

In Example 19, the subject matter of Examples 1-18 includes, wherein the at least one processor is configured to apply the first real estate possession record to a machine learning model, wherein the machine learning model perform the operations of identifying the value of the first real estate, generating the plurality of digital tokens corresponding to the value of the first real estate based on the value and the value for each digital token, transmitting the generated digital tokens to the digital token storage associated with the first real estate possessor, and recording the lien on the first real estate possession record and the record of the digital tokens transmitted to the digital token storage associated with the first real estate possessor onto a distributed ledger of the blockchain.

In Example 20, the subject matter of Examples 1-19 includes, wherein the at least one processor is configured to apply data corresponding to the second digital token relocation to a machine learning model, wherein the machine learning model performs the operations of transmitting the first portion of the second digital token relocation transmitted to the digital token storage associated with the first real estate possessor, transmitting the second portion of the digital token relocation to the digital token storage associated with the real estate recipient, and recording the record of the first and second portions being transmitted onto the distributed ledger of the blockchain.

Example 21 is a method comprising: receiving a first real estate possession record for a first real estate from a first real estate possessor; identifying a value of the first real estate; generating a plurality of digital tokens by a group of nodes of a blockchain, a number of the generated plurality of digital tokens based on the value of the first real estate based on the value and a value for each digital token, each digital token representing a fractional ownership interest in the first real estate; transmitting the generated digital tokens to a digital token storage associated with the first real estate possessor; recording a lien on the first real estate possession record and a record of the digital tokens transmitted to the digital token storage associated with the first real estate possessor onto a distributed ledger of the blockchain; initiate a first digital token relocation for a real estate recipient, the first digital token relocation transmitting a first subset of digital tokens from the digital token storage associated with the first real estate possessor to a digital token storage associated with the real estate recipient and recording the transmission of the first subset onto the distributed ledger; and periodically, during a first real estate utilization period for a real estate user: receiving an indication of a second digital token relocation from the real estate user utilizing the first real estate; transmitting a first portion of the second digital token relocation transmitted to the digital token storage associated with the first real estate possessor; transmitting a second portion of the digital token relocation to the digital token storage associated with the real estate recipient, the first and second portions being based on digital tokens stored in digital token storage of the first real estate possessor and the real estate recipient; and recording a record of the first and second portions being transmitted onto the distributed ledger of the blockchain.

Example 22 is a non-transitory computer-readable storage medium storing instructions that, when executed by at least one processor, cause the at least one processor to perform operations comprising: receiving a first real estate possession record for a first real estate from a first real estate possessor; identifying a value of the first real estate; generating a plurality of digital tokens by a group of nodes of a blockchain, a number of the generated plurality of digital tokens based on the value of the first real estate based on the value and a value for each digital token, each digital token representing a fractional ownership interest in the first real estate; transmitting the generated digital tokens to a digital token storage associated with the first real estate possessor; recording a lien on the first real estate possession record and a record of the digital tokens transmitted to the digital token storage associated with the first real estate possessor onto a distributed ledger of the blockchain; initiate a first digital token relocation for a real estate recipient, the first digital token relocation transmitting a first subset of digital tokens from the digital token storage associated with the first real estate possessor to a digital token storage associated with the real estate recipient and recording the transmission of the first subset onto the distributed ledger; and periodically, during a first real estate utilization period for a real estate user: receiving an indication of a second digital token relocation from the real estate user utilizing the first real estate; transmitting a first portion of the second digital token relocation transmitted to the digital token storage associated with the first real estate possessor; transmitting a second portion of the digital token relocation to the digital token storage associated with the real estate recipient, the first and second portions being based on digital tokens stored in digital token storage of the first real estate possessor and the real estate recipient; and recording a record of the first and second portions being transmitted onto the distributed ledger of the blockchain.

Example 23 is at least one machine-readable medium including instructions that, when executed by processing circuitry, cause the processing circuitry to perform operations to implement any of Examples 1-22.

Example 24 is an apparatus comprising means to implement any of Examples 1-22.

Example 25 is a system to implement any of Examples 1-22.

Example 26 is a method to implement any of Examples 1-22.

Although examples described herein describe features of the tokenization system using a digitized asset rights document, it is appreciated that the features of the tokenization system can apply to other forms, such as real world property ownership certificate, digital physical property title, digitized asset rights, document, physical asset registry record, physical commodity ownership record document, real estate ownership certificate, real estate possession record, tangible asset ownership record, tangible property conveyance document, deed, title, and/or the like, and/or vice versa.

Although examples described herein describe features of the tokenization system using a real world asset, it is appreciated that the features of the tokenization system can apply to other forms, such as real world property, physical property, tangible property, physical commodity, real estate property, physical asset, real estate, tangible asset, real world asset, and/or the like, and/or vice versa.

Although examples described herein describe features of the tokenization system using an asset holder, it is appreciated that the features of the tokenization system can apply to other forms, such as real world property owner, physical property owner, tangible property owner, physical commodity holder, real estate property proprietor, physical asset possessor, real estate possessor, tangible asset custodian, and/or the like, and/or vice versa.

Although examples described herein describe features of the tokenization system using an asset utilizer, it is appreciated that the features of the tokenization system can apply to other forms, such as real world property user, physical property user, tangible property occupant, physical commodity occupier, real estate property utilizer, physical asset acquirer, real estate user, tangible asset renter, and/or the like, and/or vice versa.

Although examples described herein describe features of the tokenization system using a physical commodity acquirer, it is appreciated that the features of the tokenization system can apply to other forms, such as real estate recipient, tangible asset procurer, and/or the like, and/or vice versa.

Although examples described herein describe features of the tokenization system using a digital tokens, it is appreciated that the features of the tokenization system can apply to other forms, such as digital rights tokens, virtual asset units, electronic ownership tokens, fractionalized property token, digital real estate property token, physical asset digital ledger coins, asset-backed tokens, and/or the like, and/or vice versa.

Although examples described herein describe features of the tokenization system using a digital wallet, it is appreciated that the features of the tokenization system can apply to other forms, such as digital rights token storage, virtual asset storage, electronic token data repository, tokenized account, digital Token repository, digital ledger wallet, digital token storage, virtual token storage, and/or the like, and/or vice versa.

Although examples described herein describe features of the tokenization system using an asset transaction, it is appreciated that the features of the tokenization system can apply to other forms, such as remittance, virtual asset relocation, tokenized exchange, token resource allocation, token provision, digital ledger coin transfer, digital token relocation, token disbursement, asset transaction, digital token relocation, and/or the like, and/or vice versa. Moreover, the tokens in the token disbursement, relocation, remittance, exchange, provisions and/or the like described herein can be different tokens than the tokens that represent usage rights or ownership rights.

Although examples described herein describe features of the tokenization system using an asset utilization period, it is appreciated that the features of the tokenization system can apply to other forms, such as real world property use term, physical property utilization period, occupancy span, tokenized tenure, physical asset use duration, real estate utilization period, and/or the like, and/or vice versa.

### CONCLUSION

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The various features, steps, and processes described herein may be used independently of one another, or may be combined in various ways. All possible combinations and subcombinations are intended to fall within the scope of this disclosure. In addition, certain method or process blocks may be omitted in some implementations.

What is claimed is:

1. A system comprising:
at least one processor; and
at least one memory component storing instructions that, when executed by the at least one processor, cause the at least one processor to perform operations comprising:
receiving a first real estate possession record for a first real estate from a first real estate possessor;
identifying a value of the first real estate;
generating a plurality of digital tokens by a group of nodes of a blockchain, a number of the generated plurality of digital tokens based on the value of the first real estate based on the value and a value for each digital token, each digital token representing a fractional ownership interest in the first real estate;
transmitting the generated digital tokens to a digital token storage associated with the first real estate possessor;
recording a lien on the first real estate possession record and a record of the digital tokens transmitted to the digital token storage associated with the first real estate possessor onto a distributed ledger of the blockchain;
initiate a first digital token relocation for a real estate recipient, the first digital token relocation transmitting a first subset of digital tokens from the digital token storage associated with the first real estate possessor to a digital token storage associated with the real estate recipient and recording the transmission of the first subset onto the distributed ledger;
periodically, during a first real estate utilization period for a real estate user:
receiving an indication of a second digital token relocation from the real estate user utilizing the first real estate;
transmitting a first portion of the second digital token relocation transmitted to the digital token storage associated with the first real estate possessor;
transmitting a second portion of the second digital token relocation to the digital token storage associated with the real estate recipient, the first and second portions being based on digital tokens stored in digital token storage of the first real estate possessor and the real estate recipient; and
recording a record of the first and second portions being transmitted onto the distributed ledger of the blockchain.

2. The system of claim 1, wherein the operations further comprise receiving an indication of a third digital token relocation, wherein in response to receiving the indication of the third digital token relocation: transmitting the first subset of digital tokens from the digital token storage associated with the first real estate recipient to the digital token storage associated with the real estate possessor.

3. The system of claim 2, wherein further in response to receiving the indication of the third digital token relocation: transmitting digital tokens stored in the digital token storage associated with the real estate user to the digital token storage associated with the real estate possessor and removing the lien on the first real estate possession record.

4. The system of claim 3, wherein removing the lien comprises recording a modified first real estate possession record that removes the lien or generating a new first real estate possession record without the lien.

5. The system of claim 1, wherein the operations further comprise applying a machine learning model to receive an expected return for digital token relocations submitted by real estate recipients over a period of time.

6. The system of claim 1, wherein the operations further comprise receiving a restriction on digital token relocations for real estate recipients, wherein the restriction comprises a time period for submitting digital token relocations by real estate recipients or a required value for the digital token relocations submitted by real estate recipients.

7. The system of claim 1, wherein the second digital token relocation includes the real estate user submitting the second digital token relocation using digital tokens stored in the digital token storage of the real estate user.

8. The system of claim 1, wherein the operations further comprise:
determining whether a quantity of digital tokens within the digital token storage of the real estate user meets the number of digital tokens corresponding to the value of the first real estate; and
causing recordation of a change to the first real estate possession record for the first real estate.

9. The system of claim 8, wherein the operations further comprise determining that the quantity of digital tokens within the digital token storage of the real estate user is meets or is greater than the number of digital tokens corresponding to the value of the first real estate, and causing recordation of the change comprises causing recordation of the first real estate possession record for the first real estate to the real estate user.

10. The system of claim 8, wherein the operations further comprise determining that the quantity of digital tokens within the digital token storage of the real estate user is less than the number of digital tokens corresponding to the value of the first real estate, and causing recordation of the change comprises causing recordation of the first real estate possession record for the first real estate to the first real estate possessor.

11. The system of claim 8, wherein the operations further comprise:
periodically, during a second real estate utilization period for a second real estate for the real estate user:
receiving an indication of a third digital token relocation from the real estate user utilizing the second real estate; and
transferring a number of digital tokens corresponding to at least a portion of the third digital token relocation from the digital token storage of a second real estate possessor to a digital token storage of the real estate user;
determining that a quantity of digital tokens within the digital token storage of the real estate user meets or exceeds than the number of digital tokens corresponding to the value of the second real estate; and
recording a second real estate possession record from the second real estate possessor for the second real estate to the real estate user.

12. The system of claim 11, wherein the operations further comprise: in response to recording the second real estate possession record for the second real estate to the real estate user, purging the digital tokens corresponding from a circulating supply of digital tokens.

13. The system of claim 11, wherein the quantity of digital tokens within the digital token storage of the real estate user when determining that the quantity of digital tokens within the digital token storage of the real estate user meets or exceeds than the number of digital tokens corresponding to the value of the second real estate comprises digital tokens acquired during use of the second real estate and digital tokens acquired during use of the second real estate.

14. The system of claim 1, wherein the operations further comprise:
in response to a lapse of the first real estate utilization period for the real estate user, determine whether a quantity of digital tokens within the digital token storage of the real estate user equals or exceeds the number of digital tokens corresponding to the value of the first real estate; and
in response to determining that the quantity of digital tokens within the digital token storage of the real estate user does not equal or exceed the number of digital tokens corresponding to the value of the first real estate, renew the first real estate utilization period.

15. The system of claim 1, wherein the first real estate includes a real estate property, the first real estate possession record including a digitized deed, and the first real estate possessor including a real estate property owner, wherein the first real estate utilization period is for a lease agreement, the real estate user including a tenant.

16. The system of claim 1, wherein the operations further comprise: performing optical character recognition (OCR) on the first real estate possession record, and converting data identified from performing the OCR into a standardized format, identifying the value of the first real estate being based on the converted data.

17. The system of claim 1, wherein the operations further comprise: providing the real estate user with access to the first real estate by at least one of: generating a unique access code for a digital lock or security system of the first real estate, transmitting a signal to one or more Internet of Things (IoT) devices associated with the first real estate such that the one or more IoT devices grants access to the real estate user, or automatically booking the first real estate for the real estate user for the first real estate utilization period.

18. The system of claim 1, wherein the first real estate includes a collection of physical properties, wherein the real estate user is able to use one of the physical properties, wherein the tokens represent fractional ownership for the collection of the physical properties, wherein the value of the tokens required for the transfer of ownership is the value of the collection of the physical properties.

19. The system of claim 1, wherein the at least one processor is configured to apply the first real estate possession record to a machine learning model, wherein the machine learning model perform the operations of identifying the value of the first real estate, generating the plurality of digital tokens corresponding to the value of the first real estate based on the value and the value for each digital token, transmitting the generated digital tokens to the digital token storage associated with the first real estate possessor, and recording the lien on the first real estate possession record and the record of the digital tokens transmitted to the digital token storage associated with the first real estate possessor onto a distributed ledger of the blockchain.

20. The system of claim 1, wherein the at least one processor is configured to apply data corresponding to the second digital token relocation to a machine learning model, wherein the machine learning model performs the operations of transmitting the first portion of the second digital token relocation transmitted to the digital token storage associated with the first real estate possessor, transmitting the second portion of the digital token relocation to the digital token storage associated with the real estate recipient, and recording the record of the first and second portions being transmitted onto the distributed ledger of the blockchain.

21. A method comprising:
receiving a first real estate possession record for a first real estate from a first real estate possessor;
identifying a value of the first real estate;
generating a plurality of digital tokens by a group of nodes of a blockchain, a number of the generated plurality of digital tokens based on the value of the first real estate based on the value and a value for each digital token, each digital token representing a fractional ownership interest in the first real estate;
transmitting the generated digital tokens to a digital token storage associated with the first real estate possessor;
recording a lien on the first real estate possession record and a record of the digital tokens transmitted to the digital token storage associated with the first real estate possessor onto a distributed ledger of the blockchain;
initiate a first digital token relocation for a real estate recipient, the first digital token relocation transmitting a first subset of digital tokens from the digital token storage associated with the first real estate possessor to a digital token storage associated with the real estate recipient and recording the transmission of the first subset onto the distributed ledger; and
periodically, during a first real estate utilization period for a real estate user:
receiving an indication of a second digital token relocation from the real estate user utilizing the first real estate;
transmitting a first portion of the second digital token relocation transmitted to the digital token storage associated with the first real estate possessor;
transmitting a second portion of the digital token relocation to the digital token storage associated with the real estate recipient, the first and second portions being based on digital tokens stored in digital token storage of the first real estate possessor and the real estate recipient; and
recording a record of the first and second portions being transmitted onto the distributed ledger of the blockchain.

22. A non-transitory computer-readable storage medium storing instructions that, when executed by at least one processor, cause the at least one processor to perform operations comprising:
receiving a first real estate possession record for a first real estate from a first real estate possessor;
identifying a value of the first real estate;
generating a plurality of digital tokens by a group of nodes of a blockchain, a number of the generated plurality of digital tokens based on the value of the first real estate based on the value and a value for each digital token, each digital token representing a fractional ownership interest in the first real estate;
transmitting the generated digital tokens to a digital token storage associated with the first real estate possessor;
recording a lien on the first real estate possession record and a record of the digital tokens transmitted to the digital token storage associated with the first real estate possessor onto a distributed ledger of the blockchain;
initiate a first digital token relocation for a real estate recipient, the first digital token relocation transmitting a first subset of digital tokens from the digital token storage associated with the first real estate possessor to a digital token storage associated with the real estate recipient and recording the transmission of the first subset onto the distributed ledger; and
periodically, during a first real estate utilization period for a real estate user:
receiving an indication of a second digital token relocation from the real estate user utilizing the first real estate;
transmitting a first portion of the second digital token relocation transmitted to the digital token storage associated with the first real estate possessor;
transmitting a second portion of the digital token relocation to the digital token storage associated with the real estate recipient, the first and second portions being based on digital tokens stored in digital token storage of the first real estate possessor and the real estate recipient; and
recording a record of the first and second portions being transmitted onto the distributed ledger of the blockchain.
